(19) United States
(12) Patent Application Publication
(10) Pub. No.: US 2025/0206024 A1
(43) Pub. Date: Jun. 26, 2025

(54) LIQUID EJECTING APPARATUS

(71) Applicant: BROTHER KOGYO KABUSHIKI KAISHA, Nagoya (JP)

(72) Inventors: SHOHEI ICHIKAWA, Niwa (JP); SHOJI SATO, Okazaki (JP); YUMA TANABE, Nagoya (JP)

(73) Assignee: BROTHER KOGYO KABUSHIKI KAISHA, Nagoya (JP)

(21) Appl. No.: 18/991,516

(22) Filed: Dec. 21, 2024

(30) Foreign Application Priority Data
Dec. 26, 2023 (JP) 2023-219719

(51) Int. Cl. B41J 2/165; B41J 2/045; B41J 2/14; B41J 29/00

(52) U.S. Cl. CPC B41J 2/16505; B41J 2/0451; B41J 2/04581; B41J 2/14233; B41J 2/16579; B41J 29/00; B41J 2002/14306; B41J 2002/16594

(57) ABSTRACT

A liquid ejecting apparatus includes a head, a cleaning part, and a controller. The head has a head flow passage, and a piezoelectric element which forms a part of a wall of the head flow passage. The cleaning part has a nozzle cap, a negative pressure pump, and a liquid discharge connecting flow passage. The controller is configured to execute discharge of a liquid inside the head flow passage from a nozzle by driving the negative pressure pump in a state that the nozzle is covered with the nozzle cap, obtainment of a voltage of the piezoelectric element during a period in which the liquid inside the head flow passage is being discharged from the nozzles, and output of an abnormality signal which indicates that at least a part of the cleaning part is abnormal in a case where the obtained voltage does not satisfy a liquid discharge-voltage condition.

### REFERENCE TO RELATED APPLICATIONS

This application claims priority from Japanese Patent Application No. 2023-219719 filed on Dec. 26, 2023. The entire content of the priority application is incorporated herein by reference.

### BACKGROUND ART

An ink-jet printer is known, which performs the recording by ejecting an ink from nozzles, as an example of a liquid ejecting apparatus which ejects a liquid from nozzles. For example, in a certain known ink-jet printer, purge is performed such that a pressure is applied to an ink inside a head by a pump to discharge the ink inside the ink-jet head from nozzles.

On the other hand, in another known ink-jet printer, a pump is disposed in a flow passage via which a pretreatment solution is applied to an application roller configured to apply the pretreatment solution to a sheet, before the recording. Further, electrodes are disposed each at one of portions positioned in front of and behind the pump for the flow passage. The two electrodes are connected to a discriminating circuit via a converting circuit and ADC. Any change in the impedance change between the two electrodes is detected by the discriminating circuit. Any trouble of the pump is detected based on the detected change in the impedance.

### SUMMARY

In this context, a configuration which is the same as or equivalent to the configuration of the another known ink-jet printer described above is considered to be provided in order to detect the abnormality of the pump which applies the pressure to the ink inside the head. In this case, the electrodes are required to be disposed, respectively, on the both sides of the pump for the flow passage to which the pump is connected, and/or the circuit or the like connected to the electrodes are required to be included, resulting in the increase in the size and in the production cost of the apparatus.

An object of the present disclosure is to provide a technique which contributes to the detection of the state of an apparatus including a pump which applies the pressure to a liquid inside a head, by a simple configuration.

A liquid ejecting apparatus according to an aspect of the present disclosure includes: a head, a cleaning part, and a controller. The head has a head flow passage including a nozzle, and a piezoelectric element which forms a part of a wall of the head flow passage. The cleaning part has a nozzle cap configured to cover the nozzles, a negative pressure pump configured to generate a negative pressure, and a liquid discharge connecting flow passage to connect the nozzle cap and the negative pressure pump. The controller is configured to execute discharge of a liquid inside the head flow passage from the nozzle by driving the negative pressure pump in a state that the nozzle is covered with the nozzle cap, obtainment of a voltage of the piezoelectric element during a period in which the liquid inside the head flow passage is being discharged from the nozzles, and output of an abnormality signal which indicates that at least a part of the cleaning part is abnormal in a case where the obtained voltage does not satisfy a liquid discharge-voltage condition.

A liquid ejecting apparatus according to another aspect of the present disclosure includes: a head, a positive pressure pump, a liquid receiving part, and a controller. The head has a head flow passage including a nozzle, and a piezoelectric element which forms a part of a wall of the head flow passage. The positive pressure pump is configured to apply a positive pressure to a liquid inside the head flow passage. The liquid receiving part is configured to receive the liquid discharged from the nozzle. The controller is configured to execute discharge of the liquid inside the head flow passage from the nozzle to the liquid receiving part by driving the positive pressure pump, obtainment of a voltage of the piezoelectric element during a period in which the liquid inside the head flow passage is being discharged from the nozzle to the liquid receiving part, and output of an abnormality signal to indicate that the positive pressure pump is abnormal in a case where the obtained voltage does not satisfy a liquid discharge-voltage condition.

A liquid ejecting apparatus according to still another aspect of the present disclosure includes: a head, a liquid retaining part, a supply flow passage, a gas discharge flow passage, a cleaning part, and a controller. The head has a head flow passage having a nozzle and a liquid supply port, and a piezoelectric element which forms a part of a wall of the head flow passage. The liquid retaining part is configured to retain a liquid to be supplied to the head flow passage. The supply flow passage connects a discharge port and the liquid retaining part. The gas discharge flow passage is branched from the supply flow passage and the gas discharge flow passage has a gas discharge port. The cleaning part has a gas discharge cap configured to cover the gas discharge port, a negative pressure pump configured to generate a negative pressure, and a gas discharge connecting flow passage to connect the gas discharge cap and the negative pressure pump. The controller is configured to execute discharge of a gas inside the head flow passage from the gas discharge port by driving the negative pressure pump in a state that the gas discharge port is covered with the gas discharge cap, obtainment of a voltage of the piezoelectric element during a period in which the gas inside the head flow passage is being discharged from the gas discharge port, and output of an abnormality signal which indicates that at least a part of the cleaning part is abnormal in a case where the obtained voltage does not satisfy a gas discharge-voltage condition.

According to the present disclosure, the controller is configured to detect the presence of any abnormality in the positive pressure pump or at least a part of the cleaning part including the negative pressure pump.

### BRIEF DESCRIPTION OF DRAWINGS

FIG. 1 is a view depicting the schematic configuration of a printer.

FIG. 2 is a plan view of an ink-jet head.

FIG. 3 is a sectional view taken along a line III-III depicted in FIG. 2.

FIG. 4 is a view depicting the schematic configuration of a sub tank.

FIG. 5 is a sectional view taken along a line V-V depicted in FIG. 4.

FIG. 6A is a sectional view taken along a line VIA-VIA depicted in FIG. 4, and FIG. 6B is a sectional view taken along a line VIB-VIB depicted in FIG. 6A.

FIG. 7A is a view depicting a state that a gas discharge flow passage for the black is released, and FIG. 7B is a view depicting a state that gas discharge flow passages for the color inks are released.

FIG. 8 is a view depicting an electrode disposed in a cap and a configuration for applying a voltage to the electrode.

FIG. 9A is a view illustrating a signal outputted from a signal processing circuit in a case where a nozzle is normal, and FIG. 9B is a view illustrating a signal outputted from the signal processing circuit in a case where the nozzle has an ejection amount abnormality.

FIG. 10 is a block diagram illustrating the electric configuration of the printer.

FIG. 11A is a flow chart indicating a flow of a process in a case where a cleaning instruction signal is received, FIG. 11B illustrates a relationship between a change in an obtained voltage of a piezoelectric element and a signal to be outputted in an abnormality detection process, FIG. 11C is a view illustrating a normality screen, FIG. 11D is a view illustrating an abnormality screen which indicates that at least any one of a first nozzle cap and a liquid discharge flow passage for the black is abnormal, FIG. 11E is a view illustrating an abnormality screen which indicates that at least any one of a second nozzle cap and a liquid discharge flow passage for the color is abnormal, and FIG. 11F is a view illustrating an abnormality screen which indicates that at least any one of a negative pressure pump and a common liquid discharge flow passage is abnormal.

FIG. 12A is a flow chart indicating a flow of a process in a case where a cleaning instruction signal is received in an example in which the abnormality of a maintenance unit is determined based on the change in the voltage of the piezoelectric element during a suction purge and after the suction purge, and FIG. 12B is a view illustrating a relationship between the change in the obtained voltage of the piezoelectric element and a signal to be outputted in the abnormality detection process in an example in which the abnormality of the maintenance unit is determined based on the change in the voltage of the piezoelectric element during the suction purge and after the suction purge.

FIG. 13A is a flow chart indicating a flow of a process in a case where the cleaning instruction signal is received in an example in which the trouble of the maintenance unit is determined based on the change in an obtained voltage of an individual electrode and a driving state signal, FIG. 13B is a view illustrating a relationship between the change in the obtained voltage of the piezoelectric element and the driving state signal and the signal to be outputted in the abnormality detection process, FIG. 13C is a view illustrating an abnormality screen indicating that at least any one of a switching unit, a part, of a negative pressure pump, which is other than a pump motor, and the common liquid discharge flow passage is abnormal, and FIG. 13D is a view illustrating an abnormality screen indicating that the pump motor is abnormal.

FIG. 14 is a flow chart indicating a flow of a process in a case where an inspection instruction signal is received in an example in which the abnormality of the maintenance unit is detected during an ejection inspection.

FIGS. 15A and 15B depict a flow chart indicating a flow of a process in a case where the inspection instruction signal is received in another example in which the abnormality of the maintenance unit is detected during the ejection inspection.

FIG. 16A is a flow chart indicating a flow of a process in a case where the cleaning instruction signal is received in an example in which the abnormality of the maintenance unit is detected based on the change in the voltage of the piezoelectric element during the suction purge and a gas discharge purge, FIG. 16B is a view illustrating a relationship between the change in the voltage of the piezoelectric element during the suction purge and the change in the voltage of the piezoelectric element during the gas discharge purge and a signal to be outputted in the abnormality detection process, FIG. 16C is a view illustrating a relationship between the changes of the voltage of the piezoelectric element during the suction purge for the black and the suction purge for the color and a signal to be outputted in the abnormality detection process in a case where only the change in the voltage of the piezoelectric element during the suction purge is abnormal, and FIG. 16D is a view illustrating a relationship between the changes of the voltage of the piezoelectric element during the gas discharge purge for the black and the gas discharge purge for the color and a signal to be outputted in the abnormality detection process in a case where only the change in the voltage of the piezoelectric element during the gas discharge purge is abnormal.

FIG. 17A is a view illustrating an abnormality screen indicating that at least any one of the switching unit and the negative pressure pump is abnormal, FIG. 17B is a view illustrating an abnormality screen indicating that a shaft for the black is abnormal, FIG. 17C is a view illustrating an abnormality screen indicating that a shaft for the color is abnormal, FIG. 17D is a view illustrating an abnormality screen indicating that at least any one of a gas discharge cap and the gas discharge flow passage is abnormal, and FIG. 17E is a view illustrating an abnormality screen indicating that at least any one of the negative pressure pump, the switching unit, and a liquid discharge/gas discharge common flow passage is abnormal.

FIG. 18A is a flow chart indicating a flow of a process in a case where the cleaning instruction signal is received in an example in which the abnormality of the maintenance unit is detected based on the change in the voltage of the piezoelectric element during the gas discharge purge, FIG. 18B is a view illustrating a relationship between the change in the voltage of the piezoelectric element during the gas discharge purge and a signal to be outputted in the abnormality detection process, and FIG. 18C is a view illustrating an abnormality screen indicating that at least any one of the gas discharge cap, the gas discharge flow passage, the switching unit, and the negative pressure pump is abnormal.

FIG. 19 is a schematic view depicting the configuration of a printer capable of performing the positive pressure purge.

FIG. 20A is a flow chart indicating a flow of a process in a case where the cleaning instruction signal is received in the printer depicted in FIG. 19, FIG. 20B is a view illustrating a relationship between the change in the voltage of the piezoelectric element obtained during the positive pressure purge and a signal to be outputted in the abnormality detection process, FIG. 20C is a view illustrating a normality screen indicating that the positive pressure pump is normal, and FIG. 20D is a view illustrating an abnormality screen indicating that the positive pressure pump is abnormal.

### DESCRIPTION

### Schematic Configuration of Printer

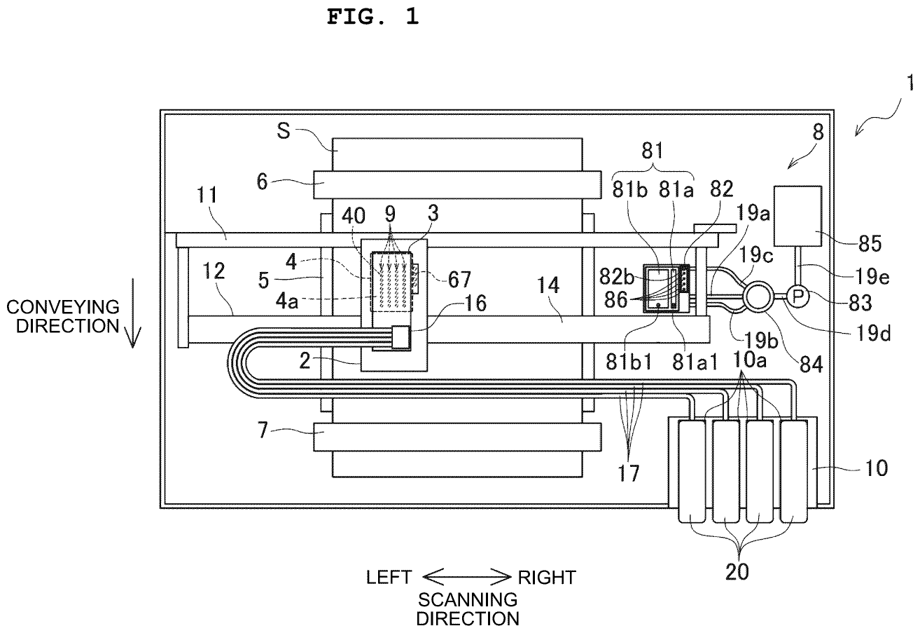

As depicted in FIG. 1, a printer 1 of the present embodiment includes a carriage 2, a sub tank 3, an ink-jet head 4, a platen 5, conveyance rollers 6 and 7, and a maintenance unit 8. Note that in the present embodiment, the printer 1 corresponds to the “liquid ejecting apparatus” of the present disclosure. Further, the ink-jet head 4 corresponds to the “head” of the present disclosure. Further, the maintenance unit 8 corresponds to the “cleaning part” of the present disclosure.

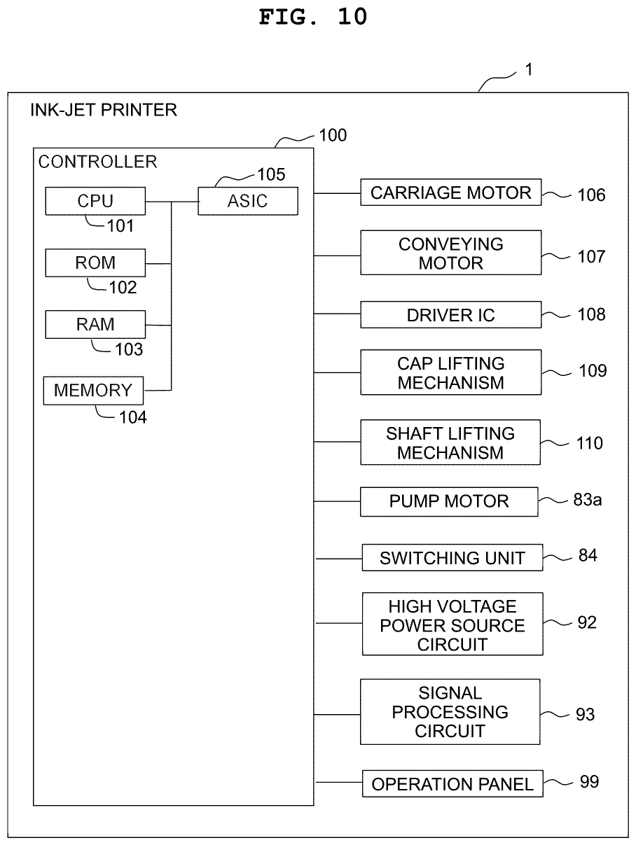

The carriage 2 is supported movably in a scanning direction by two guide rails 11 and 12. The carriage 2 is connected to a carriage motor 106 depicted in FIG. 10 by the aid of, for example, an unillustrated belt. In a case where the carriage motor 106 is driven, the carriage 2 is moved in the scanning direction along the guide rails 11 and 12. Note that the following description will be made while defining the right and the left in the scanning direction as depicted in FIG. 1.

The sub tank 3 is mounted on the carriage 2. A tube joint 16 is disposed in the upper surface of the sub tank 3. The tube joint 16 is connected to a cartridge holder 10 via four tubes 17. Further, a gas discharge unit 67, which is configured to discharge an air bubble entered the flow passage in the sub tank 3, is disposed in the right side surface of the sub tank 3. The sub tank 3 will be described in detail later.

The cartridge holder 10 includes four cartridge attaching parts 10a which are disposed side by side in the scanning direction. An ink cartridge 20 is attached removably to each of the cartridge attaching parts 10a. Inks of black, yellow, cyan, and magenta are retained, respectively, in the four ink cartridges 20 attached to the four cartridge attaching parts 10a as referred to in this order starting from the ink cartridge 20, of the four ink cartridges 20, which positioned on the right-most side in the scanning direction. Further, the inks of four colors, which are retained in the four ink cartridges 20 attached to the four cartridge attaching parts 41, are supplied to the sub tank 3 via four ink supply tubes 17, respectively. Note that in the present embodiment, each of the ink cartridges 20 corresponds to the “liquid retaining part” of the present disclosure.

The ink-jet head 4 is mounted to a lower portion of the sub tank 3. The ink-jet head 4 ejects the four color inks from a plurality of nozzles 40 formed on a nozzle surface 4a which is the lower surface of the ink-jet head 4. Note that the ink-jet head 4 will be described in detail later.

The platen 5 is positioned below the ink-jet head 4, and the platen 5 faces the nozzle surface 4a. The platen 5 extends over the entire length of the recording sheet S in the scanning direction, and the platen 5 supports the recording sheet S from therebelow.

The conveyance roller 6 is a roller which extends in the scanning direction. The conveyance roller 6 is positioned upstream of the ink-jet head 4 and the platen 5 in a conveyance direction which is orthogonal to the scanning direction. The conveyance roller 7 is a roller which extends in the scanning direction. The conveyance roller 7 is positioned downstream of the ink-jet head 4 and the platen 5 in the conveyance direction. The conveyance rollers 6 and 7 are connected to a conveyance motor 107 depicted in FIG. 10 via unillustrated gears or the like. In a case where the conveyance motor 107 is driven, the conveyance rollers 6 and 7 are rotated, and the recording sheet S is thereby conveyed in the conveyance direction.

The maintenance unit 8 is disposed at a position on the right side in the scanning direction with respect to the platen 5. The maintenance unit 8 is configured to maintain and recover the ejecting function of the ink-jet head 4. The maintenance unit 8 will be described later.

### Ink-Jet Head

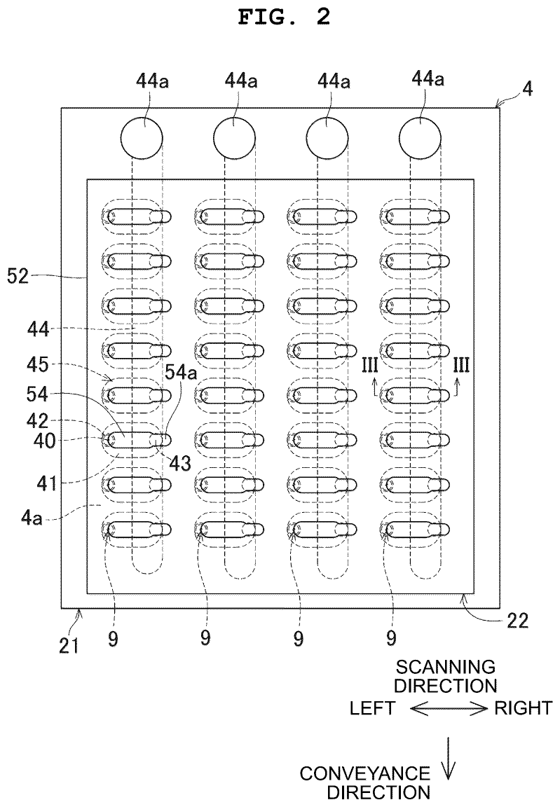

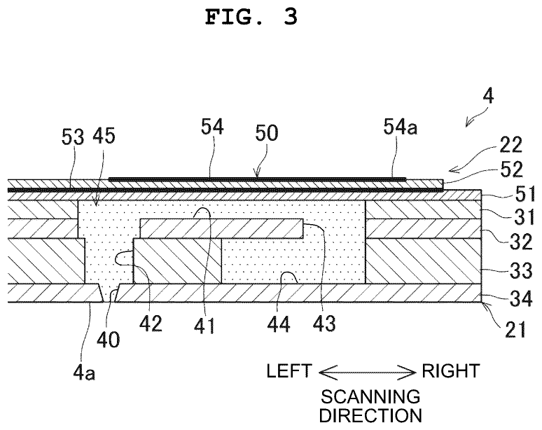

Next, the ink-jet head 4 will be described in detail below. As depicted in FIG. 2 and FIG. 3, the ink-jet head 4 includes a flow passage unit 21 and a piezoelectric actuator 22.

The flow passage unit 21 is formed by staking four plates 31 to 34 as referred to in this order from the top to the bottom. The flow passage unit 21 has a plurality of nozzles 40, a plurality of pressure chambers 41, a plurality of descenders 42, a plurality of connecting flow passages 43, and four manifolds 44.

The plurality of nozzles 40 is formed through the plate 34. Four nozzle arrays 9 are disposed side by side in the scanning direction in the plate 34. Each of the nozzle arrays 9 has nozzles, of the plurality of nozzles 40, which are aligned in the conveyance direction. The inks of black, yellow, cyan, and magenta are ejected from the nozzles 40 as referred to in this order starting from a nozzle array 9, of the nozzle arrays 9, disposed on the right-most side in the scanning direction. Note that the lower surface of the plate 34, on which the plurality of nozzles 40 is formed, is the nozzle surface 4a.

The plurality of pressure chambers 41 is provided each individually corresponding to one of the plurality of nozzles 40. The plurality of pressure chambers 41 is formed through the plate 31. Each of the pressure chambers 41 has a substantially elliptic shape in which the scanning direction is the longitudinal direction. A left end portion in the scanning direction of each of the pressure chambers 41 overlaps with a nozzle 40, of the plurality of nozzles 40, corresponding thereto in the up-down direction.

The plurality of descenders 42 is provided each individually corresponding to one of the plurality of nozzles 40. Each of the descenders 42 extends in the up-down direction over the plates 32 and 33. Each of the descenders 42 connects a nozzle 40, of the plurality of nozzles 40, corresponding thereto and the left end portion in the scanning direction of a pressure chamber 41, of the plurality of pressure chambers 41, corresponding thereto.

The plurality of connecting flow passages 43 is provided each individually corresponding to one of the plurality of pressure chambers 41. Each of the connecting flow passages 43 is formed through the plate 32. An upper end of each of the connecting flow passages 43 is connected to a right end portion in the scanning direction of a pressure chamber 41, of the plurality of pressure chambers 41, corresponding thereto.

Further, one individual flow passage 45 is formed by one nozzle 40, one pressure chamber 41, one descender 42, and one connecting flow passage 43. Accordingly, the flow passage unit 21 has a plurality of individual flow passages 45.

The four manifolds 44 correspond, respectively, to the four nozzle arrays 9. The respective manifolds 44 are formed through the plate 33. The respective manifolds 44 extend in the conveyance direction over the entire lengths of the nozzle arrays 9 corresponding thereto. Each of the manifolds 44 is connected to lower end portions of the plurality of connecting flow passages 43 corresponding to the plurality of nozzles 40 which construct one of the nozzle arrays 9 corresponding thereto. Further, each of the manifolds 44 extends to the upper surface of the plate 31 at an end portion on the upstream side in the conveyance direction of the plate 31. An opening in the upper surface of the plate 31 forms an ink supply port 44a.

Note that in the present embodiment, the manifold 44 corresponds to the “common flow passage” of the present disclosure. Further, a combination of the plurality of individual flow passages 45 and the four manifolds 44 corresponds to the “head flow passage” of the present disclosure. Further, a combination of individual flow passage 45, of the plurality of individual flow passages 45, including the nozzles 40 constructing the rightmost nozzle array 9 from which the black ink is ejected and the rightmost manifold 44 in the scanning direction connected to the above-described individual flow passages 45 corresponds to the “first head flow passage” of the present disclosure. Further, a combination of individual flow passages 45, of the plurality of individual flow passages 45, including the nozzles 40 constructing the three nozzle arrays 9 on the left side from each of which one of the color inks is ejected and the three manifolds 44 on the left side in the scanning direction connected to the above-described individual flow passages 45 corresponds to the “second head flow passage” of the present disclosure. Furthermore, the ink supply port 44a corresponds to the “liquid supply port” of the present disclosure.

The piezoelectric actuator 22 has piezoelectric layers 51 and 52, a common electrode 53, and a plurality of individual electrodes 54. The piezoelectric layers 51 and 52 are composed of a piezoelectric material containing, as a main component thereof, lead titanate zirconate as a mixed crystal of lead titanate and lead zirconate. The piezoelectric layer 51 is disposed to cover the plurality of pressure chambers 41 on the upper surface of the plate 31. Note that a layer, which is composed of an insulative material such as a synthetic resin material or the like other than the piezoelectric material, may be disposed in place of the piezoelectric layer 51. The piezoelectric layer 52 is disposed on the upper surface of the piezoelectric layer 51, and the piezoelectric layer 52 extends continuously over the plurality of pressure chambers 41.

The common electrode 53 extends continuously over the plurality of pressure chambers 41 between the piezoelectric layer 51 and the piezoelectric layer 52. The common electrode 53 is connected, for example, to an unillustrated power source via an unillustrated wiring member, and the common electrode 53 is maintained at the ground electric potential.

The plurality of individual electrodes 54 is provided individually each corresponding to one of the plurality of pressure chambers 41. The individual electrode 54 has an elliptic shape which is one size smaller than the pressure chamber 41, with the scanning direction being the longitudinal direction thereof as viewed in a plan view. Each of the plurality of individual electrodes 54 overlaps with a central portion of one of the plurality of pressure chambers 41 in the up-down direction. Further, the right end portion of the individual electrode 54 extends to a position at which the individual electrode 54 does not overlap with the pressure chamber 41 in the up-down direction. A forward end portion of the right end portion of the individual electrode 54 is a connecting terminal 54a. The connecting terminal 54a is connected to a driver IC 108 depicted in FIG. 10 via an unillustrated wiring member. Further, the voltages of the plurality of individual electrodes 54 is individually switched by the driver IC 108 between the ground electric potential and a predetermined driving voltage which is, for example, about 20 V.

Further, portions of the piezoelectric layer 52, each of which is interposed between the common electrode 53 and one of the plurality of individual electrodes 54, are polarized in the up-down direction corresponding to the common electrode 53 and the plurality of individual electrodes 54 disposed as described above. Further, portions of the piezoelectric layer 22, each of which overlaps with one of the pressure chambers 41 in the up-down direction, are piezoelectric elements 50 each of which applies the pressure to the inks inside one of the pressure chambers 41. Furthermore, each of the piezoelectric elements 50 forms an upper wall of a pressure chamber 41, of the pressure chambers 41, corresponding thereto. Note that in the present embodiment, a piezoelectric element 50, of the plurality of piezoelectric elements 50, which forms the wall of a pressure chamber 41, of the plurality of pressure chambers 40, corresponding to a nozzle 40, of the plurality of nozzles 40, which ejects the black ink, corresponds to the “first piezoelectric element” of the present disclosure. Moreover, a piezoelectric element 50, of the plurality of piezoelectric elements 50, which forms the wall of a pressure chamber 41, of the plurality of pressure chambers 40, corresponding to a nozzle 40, of the plurality of nozzles 40, which ejects one of the color inks, corresponds to the “second piezoelectric element” of the present disclosure.

A method of driving a piezoelectric element 50 to thereby eject the ink from a nozzle 40 corresponding to the piezoelectric element 50 will now be described. In the printer 1, each of the individual electrodes 54 is retained at the ground electric potential by the driver IC 108 in a standby state in which no ink is ejected from each of the nozzles 40. In a case where the ink is to be ejected from a certain nozzle 40, the electric potential of an individual electrode 54 corresponding to the certain nozzle 40 is switched from the ground electric potential to the driving electric potential by the driver IC 108. In a case where the electric potential of the individual electrode 54 is switched to the driving electric potential, an electric field is generated at the portion of the piezoelectric layer 52 interposed between the individual electrode 54 and the common electrode 53 in accordance with the difference in the electric potential between the individual electrode 54 and the common electrode 53. The portion of the piezoelectric layer 52 is shrunk by the electric field. The piezoelectric element 50 is deformed so that the entirety of the piezoelectric element 50 protrudes toward a pressure chamber 41 corresponding to the certain nozzle 40. Accordingly, the volume of the pressure chamber 41 is decreased, and thus the pressure of the ink inside the pressure chamber is increased, thereby ejecting the ink from the certain nozzle 40 which is communicated with the pressure chamber 41.

### Sub Tank

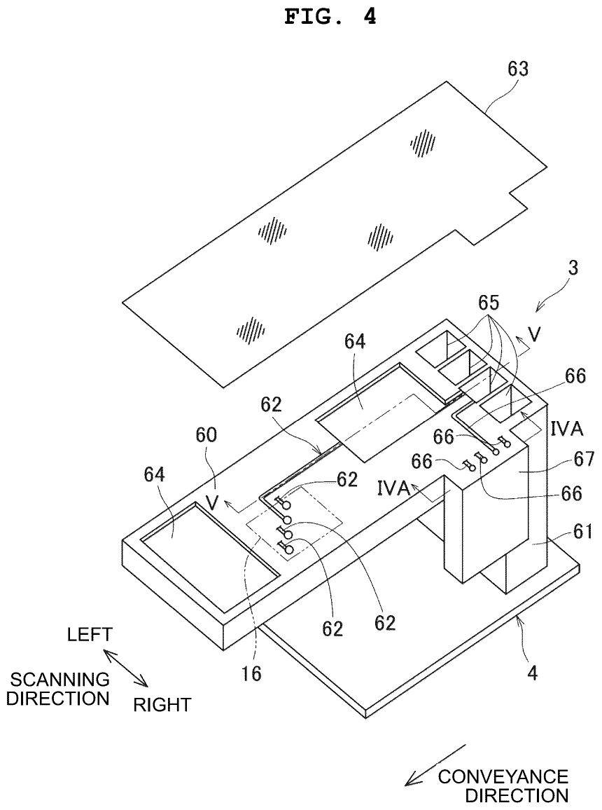

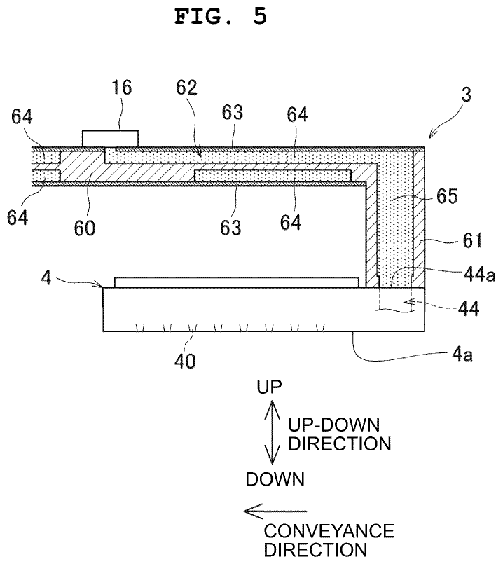

Next, the configuration of the sub tank 3 will be specifically described. As depicted in FIG. 4 and FIG. 5, the sub tank 3 has a main body portion 60 which extends horizontally, and a connecting portion 61 which extends vertically downwardly from an upstream end portion in the conveyance direction of the main body portion 60. The sub tank 3 includes four ink flow passages 62 which are formed therein and through which the four color inks described above flow, respectively. Note that in FIG. 4, in order to simplify the drawing, only the entirety of one ink flow passage 62, which is included in the four ink flow passages 62, is depicted, and parts of the remaining three ink flow passages 62 are omitted from the illustration. Further, in FIG. 5, the ink-jet head 4 is depicted in a side view, not in a cross-sectional view.

One end portions of the four ink flow passages 62 are disposed in the tube joint 16 as described above. Further, the four tubes 17 as described above are connected to the four ink flow passages 62 in the tube joint 16. Note that in the present embodiment, a combination of each of the four tubes 17 and one of the four ink flow passages 62 corresponds to the “supply flow passage” of the present disclosure.

Further, each of the ink flow passages 62 includes a damper chamber 64 which is formed in the main body portion 60 and a communication flow passage 65 which is formed in the connecting portion 61. Flexible films 63 are stuck to both upper and lower surfaces of the main body portion 60, respectively. The flow passage, which is formed in the main body portion 60 and which includes the damper chamber 64, is covered with the films 63. The cross-section of the damper chamber 64 is flat as compared with flow passage portions connected to the upstream side and the downstream side of the damper chamber 64 of the ink flow passage 62. The damper chamber 64 absorbs the pressure fluctuation of the ink flowing through the ink flow passage 62 by the deformation of the films 63. The connecting portion 61 of the sub tank 3 is connected to the ink-jet head 4. Accordingly, the lower end of the communication flow passage 65 is connected to the ink supply port 44a of the ink-jet head 4. Furthermore, the four color inks, which flow through the four ink flow passages 62, are supplied to the ink-jet head 4 from the four ink supply ports 44a, respectively.

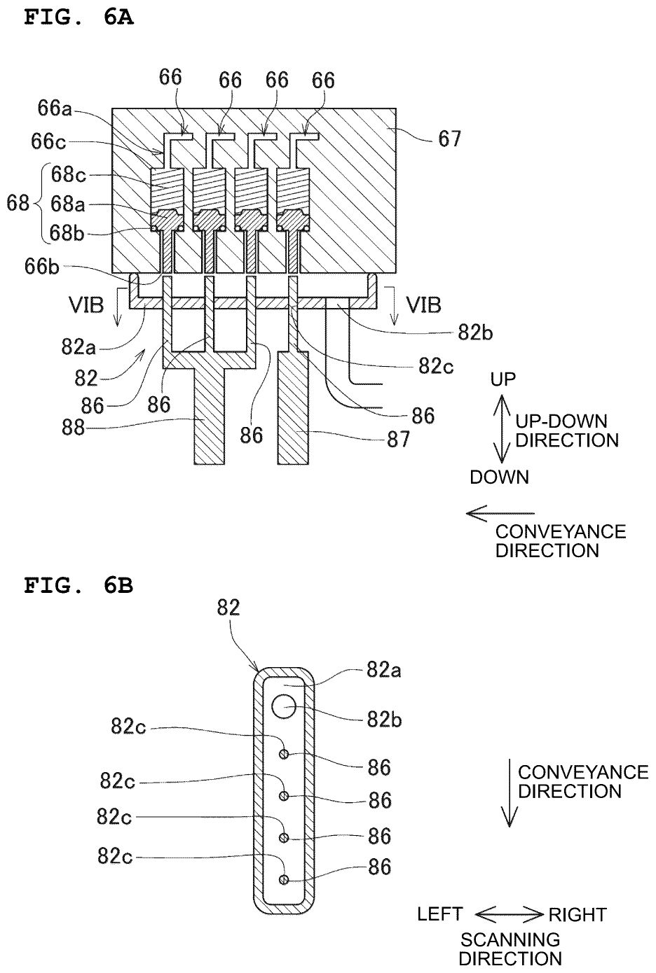

Moreover, four gas discharge flow passages 66, which are branched from the four ink flow passages 62 respectively, are formed in the main body portion 60. As depicted in FIG. 4, the four gas discharge flow passages 66 extend to a gas discharge unit 67 which is disposed in a right side surface of the sub tank 3. Further, as depicted in FIG. 6A, a flow passage portion 66a of each of the gas discharge flow passages 66, which is positioned in the gas discharge unit 67, extends in the up-down direction. A lower end of the flow passage portion 66a is a gas discharge port 66b.

Furthermore, a valve accommodating chamber 66c is disposed in the flow passage portion 66a of each of the gas discharge flow passages 66. The valve accommodating chamber 66c accommodates a valve 68. The valve 68 is configured to open and close the gas discharge flow passage 66. The valve 68 has a main valve body 68a, an O-ring 68b, and a spring 68c. An upper end portion of the main valve body 68a is accommodated in the valve accommodating chamber 66c. Further, the main valve body 68a extends downwardly toward the gas discharge port 66b from a portion thereof positioned in the valve accommodating chamber 66c. The O-ring 68b is disposed at a lower end portion of the valve accommodating chamber 66c. The spring 68c urges the main valve body 68a toward the O-ring 68b.

Further, in a state that the main valve body 68a is not pressed by a shaft 86 described later, the main valve body 68a is pressed against the O-ring 68b by the urging force of the spring 68c, and the valve 68 is closed in this state. Further, in a case where the main valve body 68a is pressed by the shaft 86 described later, the main valve body 68a is pushed upwardly against the urging force of the spring 68c, and the main valve body 68a is separated from the O-ring 68b. The valve 68 is open in this state. In this context, the valve 68 is publicly known, as described, for example, in Japanese Patent Application Laid-Open No. 2017-177773.

### Maintenance Unit

As depicted in FIG. 1, the maintenance unit 8 includes a nozzle cap unit 81, a gas discharge cap 82, a negative pressure pump 83, a switching unit 84, and a waste liquid tank 85.

As depicted in FIG. 1, the nozzle cap unit 81 is constructed by integrating a first nozzle cap 81a and a second nozzle cap 81b into one unit. The second nozzle cap 81b is disposed to be adjacent to the first nozzle cap 81a on the left side in the scanning direction. In a case where the carriage 2 is moved to a maintenance position disposed on the right side of the platen 5, the first nozzle cap 81a faces the rightmost nozzle array 9, and the second nozzle cap 81b faces the three nozzle arrays 9 on the left side. Further, the nozzle caps 81a, 81b have connecting ports 81a1, 81b1 at end portions thereof, respectively, on the downstream side in the conveyance direction.

As depicted in FIG. 1, the gas discharge cap 82 is disposed on the right side of the nozzle cap unit 81. In a case where the carriage 2 is moved to the maintenance position, the gas discharge cap 82 faces the four gas discharge ports 66b of the gas discharge unit 67. Further, as depicted in FIG. 6A and FIG. 6B, a bottom portion 82a of the gas discharge cap 82 has a connecting port 82b which is disposed at an end portion thereof on the upstream side in the conveyance direction. Further, the bottom portion 82a of the gas discharge cap 82 has four through-holes 82c which are disposed at portions thereof on the downstream side from the connecting port 82b in the conveyance direction and each of which is configured to cause the shaft 86 to penetrate therethrough, as will be described later.

The nozzle cap unit 81 and the gas discharge cap 82 are integrally movable upwardly/downwardly by a cap lifting mechanism 109 depicted in FIG. 10. Further, in a case where the nozzle cap unit 81 and the gas discharge cap 82 are moved upwardly by the cap lifting mechanism 109 in a state that the carriage 2 is located at the maintenance position, the nozzle cap unit 81 is brought in tight contact with the nozzle surface 4a, and the gas discharge cap 82 is brought in tight contact with the lower surface of the gas discharge unit 67. With this, the nozzles 40 constructing the rightmost nozzle array 9 are covered with the first nozzle cap 81a, the nozzles 40 constructing the three nozzle arrays 9 on the left side are covered with the second nozzle cap 81b, and the four gas discharge ports 66b are covered with the gas discharge cap 82. Note that in the following description, the above-described state is referred to as a “capped state” in some cases.

Note that each of the first nozzle cap 81a and the second nozzle cap 81b is not limited to the cap which cover the nozzles 40 by being brought in tight contact with the nozzle surface 4a. For example, in a case where the ink-jet head 4 has a frame which is disposed to surround the nozzle surface 4a in order to protect the nozzles 40, the nozzles 40 may be covered by causing the first nozzle cap 81a and the second nozzle cap 81b to be brought in tight contact with the frame.

On the other hand, in a case where the nozzle cap unit 81 and the gas discharge cap 82 are moved downwardly by the cap lifting mechanism 109, the nozzle cap unit 81 is separated from the nozzle surface 4a, and the gas discharge cap 82 is separated from the lower surface of the gas discharge unit 67.

Further, as depicted in FIG. 6A and FIG. 6B, the gas discharge cap 82 includes four rod-shaped shafts 86 which extend in the up-down direction. The four shafts 86 are disposed side by side in the conveyance direction. The four shafts 86 are inserted, respectively, into the four through-holes 82c of the gas discharge cap 82 and penetrate through the bottom portion 82a of the gas discharge cap 82 in the up-down direction.

The four shafts 86 overlap with the four gas discharge ports 66b of the four gas discharge flow passages 66 in the up-down direction in a state that the carriage 2 is located at the maintenance position. A shaft 86, of the four shafts 86, which is disposed on the upstream-most side in the conveyance direction, has a lower end portion which is connected to a support part 87. The support part 87 is configured to be movable upwardly/downwardly by a shaft lifting mechanism 110 depicted in FIG. 10.

Further, three shafts 86, of the four shafts 86, which are disposed on the downstream side in the conveyance direction, have lower end portions are connected to a support part 88 so that the three shafts 86 are connected to one another. The support part 88 is configured to be movable upwardly/downwardly individually from the support part 87 by the shaft lifting mechanism 110. Note that the shaft lifting mechanism 110 may move the support parts 87, 88 upwardly/downwardly in cooperation with the switching performed by the switching unit 84 described later, as described, for example, in Japanese Patent Application Laid-Open No. 2017-177773.

In a state that the support parts 87, 88 are moved downwardly, as depicted in FIG. 6A, the main valve body 68a is not pressed by the shaft 86, the main valve body 68a is pressed against the O-ring 68b by the urging force of the spring 68c, and the valve 68 is closed in this state.

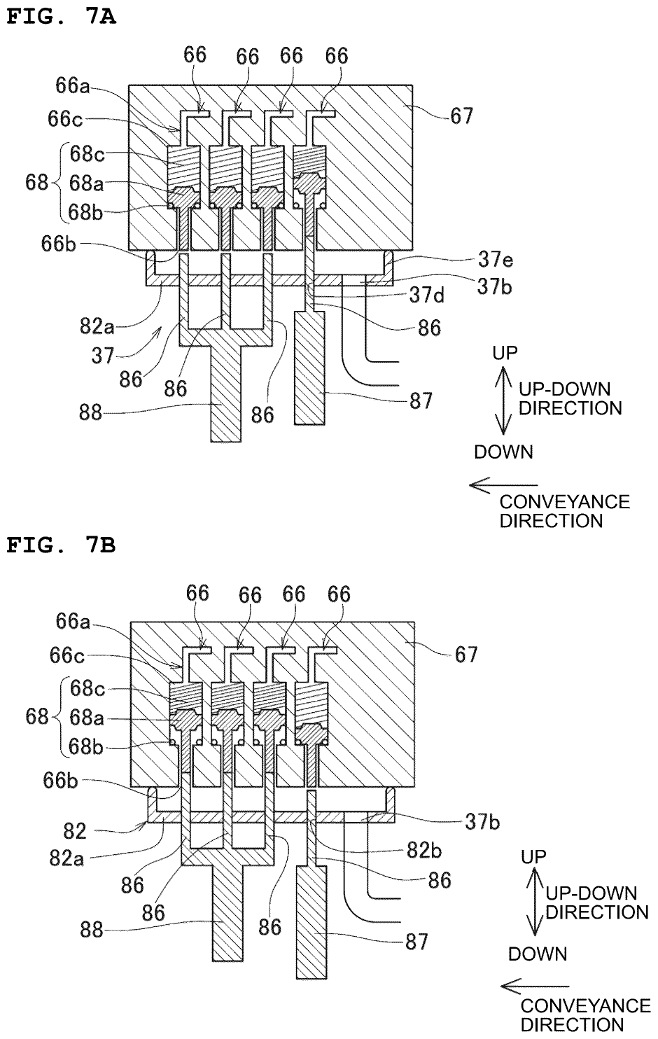

In a case where the support part 87 is moved upwardly in the capped state, as depicted in FIG. 7A, the shaft 86, which is disposed on the upstream-most side in the conveyance direction among the four shafts 86, is moved upwardly, the main valve body 68a of the valve 68, which is disposed on the upstream-most side in the conveyance direction, is pushed upwardly against the urging force of the spring 68c by the shaft 86, and the valve 68 is opened.

In a case where the support part 88 is moved upwardly in the capped state, as depicted in FIG. 7B, the three shafts 86, which are disposed on the downstream side in the conveyance direction, are moved upwardly, the main valve bodies 68a of the three valves 68, which are disposed on the downstream side in the conveyance direction, are pushed upwardly against the urging force of the springs 68c by the shafts 86, and the three valves 68 are opened.

The negative pressure pump 83 is, for example, a tube pump. The negative pressure pump 83 has a pump motor 83a depicted in FIG. 10. The negative pressure pump 83 generates a negative pressure in accordance with the driving of the pump motor 83a. The switching unit 84 is connected to the connecting port 81a1 of the first nozzle cap 81a via a tube 19a. Further, the switching unit 84 is connected to the connecting port 81b1 of the second nozzle cap 81b via a tube 19b. Furthermore, the switching unit 84 is connected to the connecting port 82b of the gas discharge cap 82 via a tube 19c. Moreover, the switching unit 84 is connected to the negative pressure pump 83 via a tube 19d. The switching unit 84 performs switching among a state that the tube 19a and the tube 19d are connected to each other, a state that the tube 19b and the tube 19d are connected to each other, and a state that the tube 19c and the tube 19d are connected to each other. Further, the negative pressure pump 83 is connected to the waste liquid tank 85 via a tube 19e.

Note that in the present embodiment, the tubes 19a, 19b and 19d each correspond to the “liquid discharge connecting flow passage” of the present disclosure. Further, the tube 19a corresponds to the “first liquid discharge connecting flow passage” of the present disclosure. Furthermore, the tube 19b corresponds to the “second liquid discharge connecting flow passage” of the present disclosure. Moreover, the tubes 19c and 19d each correspond to the “gas discharge connecting flow passage” of the present disclosure.

### Operation of Maintenance Unit

In the maintenance unit 8 as described above, the pump motor 83a of the negative pressure pump 83 is driven after connecting the first nozzle cap 81a and the negative pressure pump 83 by connecting the tube 19a and the tube 19d by the switching unit 84 in the capped state described above. By doing so, the suction purge for the black can be performed, in which the black ink inside the ink-jet head 4 is discharged to the first nozzle cap 81a from the plurality of nozzles 40 which constructs the rightmost nozzle array 9 in the scanning direction.

Further, in the maintenance unit 8, the pump motor 83a of the negative pressure pump 83 is driven after connecting the second nozzle cap 81b and the negative pressure pump 83 by connecting the tube 19b and the tube 19d by the switching unit 84 in the capped state described above. By doing so, the suction purge for the color can be performed, in which the yellow, cyan, and magenta inks inside the ink-jet head 4 are discharged to the second nozzle cap 81b from the nozzles 40 which construct the three nozzle arrays 9 on the left side in the scanning direction.

Further, in the maintenance unit 8, the pump motor 83a of the negative pressure pump 83 is driven after connecting the gas discharge cap 82 and the negative pressure pump 83 by connecting the tube 19c and the tube 19d by the switching unit 84 in the capped state described above and by opening the upstream-most valve 68 in the conveyance direction as depicted in FIG. 7A. By doing so, the gas discharge purge for the black can be performed, wherein the gas, which is inside the gas discharge flow passage 66 corresponding to the rightmost nozzle array 9 in the scanning direction, is discharged to the gas discharge cap 82. During the gas discharge purge for the black, the black ink inside the corresponding ink flow passage 62 is discharged to the gas discharge cap 82 via the gas discharge flow passage 66 together with the gas inside the gas discharge flow passage 66.

Further, in the maintenance unit 8, the pump motor 83a of the negative pressure pump 83 is driven after connecting the gas discharge cap 82 and the negative pressure pump 83 by connecting the tube 19c and the tube 19d by the switching unit 84 in the capped state described above and opening the three downstream valves 68 in the conveyance direction as depicted in FIG. 7B. By doing so, the gas discharge purge for the color can be performed, wherein the gas, which is inside the three gas discharge flow passages 66 corresponding to the three nozzle arrays 9 on the left side in the scanning direction, is discharged to the gas discharge cap 82. During the gas discharge purge for the color, the color inks inside the three corresponding ink flow passages 62 are discharged to the gas discharge cap 82 via the gas discharge flow passages 66 together with the gas inside the gas discharge flow passages 66.

Furthermore, the inks, which are discharged by the suction purge for the black, the suction purge for the color, the gas discharge purge for the black, and the gas discharge purge for the color, are retained in the waste liquid tank 85.

### Ejection Inspection Part

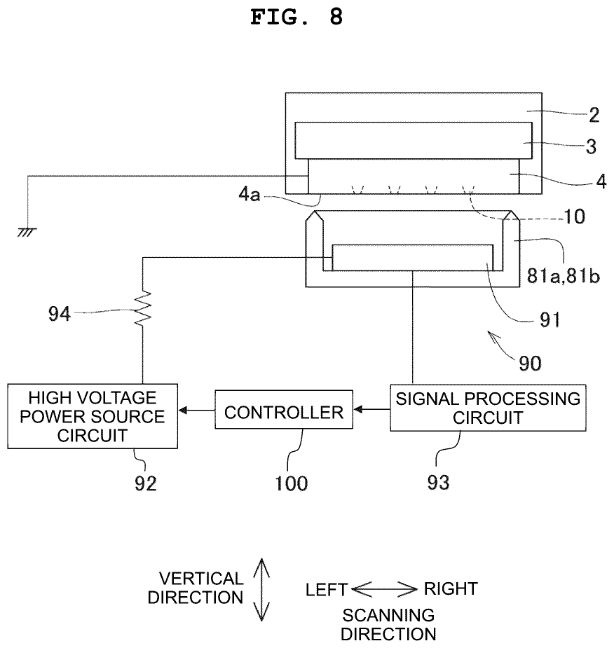

As depicted in FIG. 8, the printer 1 includes an ejection inspection part 90. The ejection inspection part 90 has an electrode 91, a high voltage power source circuit 92, a signal processing circuit 93, and a resistor 94. Note that in the present embodiment, the ejection inspection part 90 corresponds to the “ejection inspection signal output unit” of the present disclosure.

The electrode 91 has a rectangular planar shape. The electrode 91 is disposed in each of the first nozzle cap 81a and the second nozzle cap 81b. The electrode 91 is connected to the high voltage power source circuit 92 via the resistor 94. Further, the high voltage power source circuit 92 applies a predetermined voltage of, for example, approximately 600 V to the electrode 91. On the other hand, the flow passage unit 21 of the ink-jet head 4 is retained at the ground electric potential. Accordingly, the difference in the electric potential is generated between the ink-jet head 4 and the electrode 91. The signal processing circuit 93 is connected to the electrode 91. The signal processing circuit 93 includes, for example, a differentiating circuit. The signal processing circuit 93 outputs an inspection signal which is a voltage signal depending on the voltage of the electrode 91. However, the inspection signal, which is outputted from the signal processing circuit 93, may be a current signal.

Further, in the present embodiment, the driving for inspection can be performed with respect to each of the plurality of nozzles 40; in the driving for inspection, the ink-jet head 4 is driven so that the ink is ejected from each of the plurality of nozzles 40 in a state that the voltage is applied to the electrode 91 by the high voltage power source circuit 92 after the cap unit 81 is caused to be in the capped state as described above.

In a case where the ink is ejected from the nozzle 40 by the driving for inspection, the ejected ink is charged by the difference in the electric potential between the electrode 91 and the ink-jet head 4. Further, the electric potential of the electrode 91 changes as the charged ink approaches the electrode 91 and until the ink lands on the electrode 91. Further, after the charged ink has landed on the electrode 91, the electric potential of the electrode 91 returns to the electric potential before the ejection, while being attenuated.

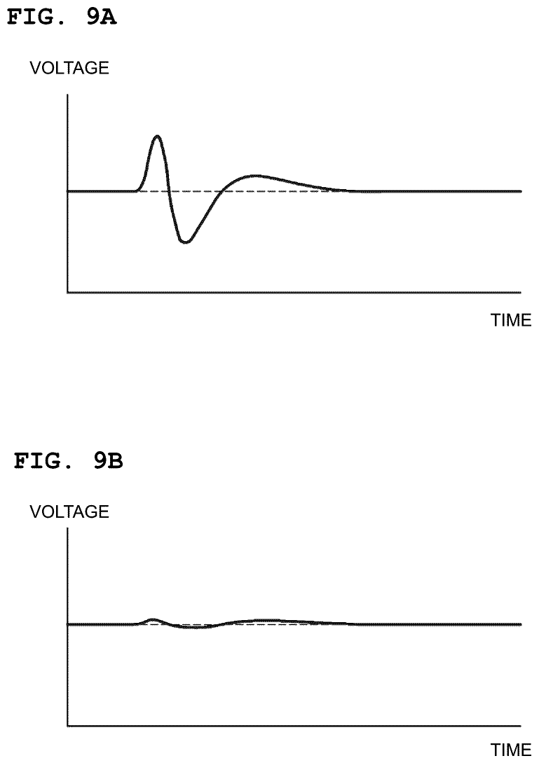

With this, in a case where the ink is ejected normally from the nozzle 40 by the driving for inspection, the voltage of the inspection signal, which is outputted from the signal processing circuit 93, rises and then lowers as depicted in FIG. 9A. After that, the voltage repeats the rising and the lowering, while being attenuated, and the voltage returns to the voltage before the driving for inspection.

On the other hand, in a case where the nozzle 40 is abnormal, and an ink amount, which is the amount of the ink ejected from the nozzle 40 by the driving for inspection, is smaller than the amount of the ink ejected in the normal state, the change in the voltage of the inspection signal outputted from the signal processing circuit 93 is small as depicted in FIG. 9B as compared with a case in which the ink is ejected normally from the nozzle 40. In this context, the situation, in which the ejection amount of the ink is smaller than the ejection amount in the case where the ink is ejected normally from the nozzle 40, includes a situation in which the ink is not ejected. In a case where the ink is not ejected from the nozzle 40 by the driving for inspection, the voltage of the inspection signal outputted from the signal processing circuit 93 hardly changes.

As described above, in the present embodiment, the change in the voltage of the inspection signal outputted from the signal processing circuit 93 differs depending on whether the ink is ejected normally from the nozzle 40 in a case where the driving for inspection is performed. That is, the inspection signal, which is outputted from the signal processing circuit 93, is a signal indicating whether or not the nozzle 40 is the abnormal nozzle which has any abnormality regarding the ejection of the ink.

In this context, in the present embodiment, the configuration is made such that the predetermined voltage is applied to the electrode 91, the ink-jet head 4 is retained at the ground electric potential, and the signal processing circuit 93 outputs the signal depending on the voltage of the electrode 91. However, the present disclosure is not limited to this. The following configuration may be allowable: the electrode 91 is retained at the ground electric potential, and the difference in the electric potential is generated between the electrode 91 and the ink-jet head 4 by applying the predetermined voltage to the ink-jet head 4; and the signal processing circuit 93 is connected to the ink-jet head 4 and outputs the inspection signal depending on the voltage of the ink-jet head 4.

### Electric Configuration of Printer

Next, the electric configuration of the printer 1 will be described. As depicted in FIG. 10, the printer 1 includes a controller 100. The controller 100 is constructed of, for example, CPU 101, ROM 102, RAM 103, a memory 104, and ASIC 105.

The controller 100 controls, for example, the carriage motor 106, the conveyance motor 107, the driver IC 108, the cap lifting mechanism 109, the shaft lifting mechanism 110, the pump motor 83a of the negative pressure pump 83, the switching unit 84, the high voltage power source circuit 92, and the signal processing circuit 93. Note that in the present embodiment, the controller 100 controls the ink-jet head 4 by controlling the driver IC 108.

Further, the printer 1 includes an operation panel 99 in addition to the constitutive components as described above. The operation panel 99 is, for example, a touch panel which is disposed in the casing of the printer 1. The controller 100 controls the operation panel 99 so as to cause the operation panel 99 to display, for example, various screens thereon. Furthermore, in a case where the operation panel 99 is operated by a user, a signal, which corresponds to the operation by the user, is transmitted from the operation panel 99 to the controller 100. Note that in the present embodiment, the operation panel 99 corresponds to the “display” of the present disclosure. Moreover, a display part such as a liquid crystal display or the like and an operation part such as a button may be distinctly provided, in place of the operation panel 99.

Further, in the controller 100, only CPU 101 may perform various processes, only ASIC 105 may perform various processes, or CPU 101 and ASIC 105 may cooperate and perform various processes. Furthermore, in the controller 100, one CPU 101 may perform a process singly, or a plurality of CPUs 101 may perform a process in a shared manner. Moreover, in the controller 100, one ASIC 105 may perform a process singly, or a plurality of ASICs 105 may perform a process in a shared manner.

### Process During Recording

In the printer 1, the controller 100 repeatedly performs a recording pass of causing the ink-jet head 4 to eject the inks from the plurality of nozzles 40 to the recording sheet S by controlling the driver IC 108 while moving the carriage 2 in the scanning direction by controlling the carriage motor 106, and a conveyance operation of causing the conveyance rollers 6 and 7 to convey the recording sheet S in the conveyance direction by controlling the conveyance motor 107. By doing so, recording is performed on the recording sheet S.

Process in a case where a cleaning instruction signal is received

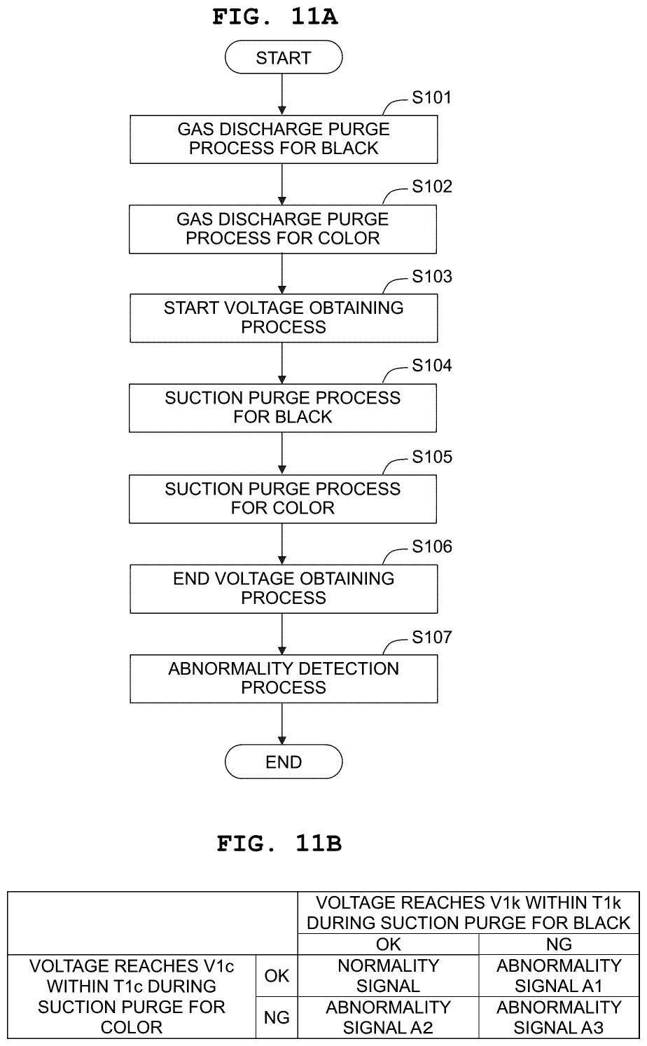

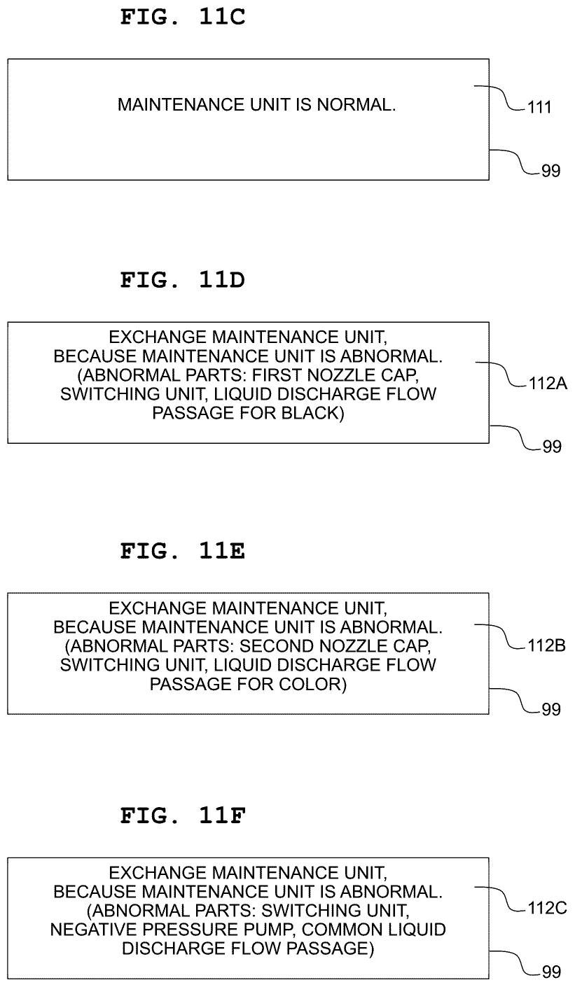

Next, a process, which is performed by the controller 100 in the present embodiment in a case where a cleaning instruction signal of instructing the controller 100 to perform the cleaning for the nozzles 40 is received, will be described. In the present embodiment, the operation panel 99 transmits the cleaning instruction signal in a case where an operation of instructing the controller 100 to perform the cleaning for the nozzles 40 is performed by the user on the operation panel 99, and the controller 100 receives the cleaning instruction signal. In a case where the controller 100 receives the cleaning instruction signal, the controller 100 perform a process in accordance with a flow chart indicated in FIG. 11A.

The process will be described in detail below. In a case where the controller 100 receives the cleaning instruction signal, the controller 100 executes a gas discharge purge process for the black (S101). In the gas discharge purge process for the black, the controller 100 controls, for example, the carriage motor 106, the cap lifting mechanism 109, the shaft lifting mechanism 110, the switching unit 84, and the pump motor 83a so as to perform the gas discharge purge for the black described above.

Subsequently, the controller 100 executes a gas discharge purge process for the color (S102). In the gas discharge purge process for the color, the controller 100 controls, for example, the carriage motor 106, the cap lifting mechanism 109, the shaft lifting mechanism 110, the switching unit 84, and the pump motor 83a so as to perform the gas discharge purge for the color described above.

Subsequently, the controller 100 starts a voltage obtaining process (S103). In the voltage obtaining process, the controller 100 obtains the voltage of the individual electrode 54, and thus the controller 100 obtains the voltage of the piezoelectric element 50. Details of the obtainment of the voltage of the piezoelectric element 50 in the voltage obtaining process will be described later.

Subsequently, the controller 100 executes a suction purge process for the black (S104). In the suction purge process for the black, the controller 100 controls, for example, the carriage motor 106, the switching unit 84, the cap lifting mechanism 109, and the pump motor 83a so as to perform the suction purge for the black described above. Further, in the voltage obtaining process started in S103, the voltage of the piezoelectric element 50 corresponding to any nozzle 40 from which the black ink is (to be) ejected is obtained during the suction purge for the black.

Subsequently, the controller 100 executes a suction purge process for the color (S105). In the suction purge process for the color, the controller 100 controls, for example, the carriage motor 106, the switching unit 84, the cap lifting mechanism 109, and the pump motor 83a so as to perform the suction purge for the color described above. Further, in the voltage obtaining process started in S103, the voltage of the piezoelectric element 50 corresponding to any nozzle 40 from which the color ink is (to be) ejected is obtained during the suction purge for the color.

Note that in the present embodiment, the suction purge for the black and the suction purge for the color each correspond to the “liquid discharge process” of the present disclosure. Further, the suction purge process for the black corresponds to the “first liquid discharge process” of the present disclosure. The purge process for the color corresponds to the “second liquid discharge process” of the present disclosure. Furthermore, the process of the voltage obtaining process, which is performed during the suction purge process for the black, corresponds to the “first voltage obtaining process” of the present disclosure. The process, which is performed during the suction purge process for the color, corresponds to the “second voltage obtaining process” of the present disclosure.

Subsequently, the controller 100 ends the voltage obtaining process (S106), and the controller 100 executes an abnormality detection process (S107). In the abnormality detection process, the controller 100 outputs, to the operation panel 99, a signal which depends on the change in the voltage of the piezoelectric element 50 obtained during the suction purge for the black and the change in the voltage of the piezoelectric element 50 obtained during the suction purge for the color in the voltage obtaining process.

Specifically, as depicted in FIG. 11B, in a case where the voltage of the piezoelectric element 50 reaches a voltage V1k within a time T1k after the start of the suction purge for the black and the voltage of the piezoelectric element 50 reaches a voltage V1c within a time T1c after the start of the suction purge for the color, the controller 100 outputs a normality signal to the operation panel 99. By doing so, as depicted in FIG. 11C, the controller 100 causes the operation panel 99 to display a normality screen 111 which indicates that the maintenance unit 8 is normal. In this context, the voltage V1k and the voltage V1c may be a same voltage, or the voltage V1k and the voltage V1c may be different voltages. Further, the time T1k and the time T1c may be an identical time, or the time T1k and the time T1c may be different times.

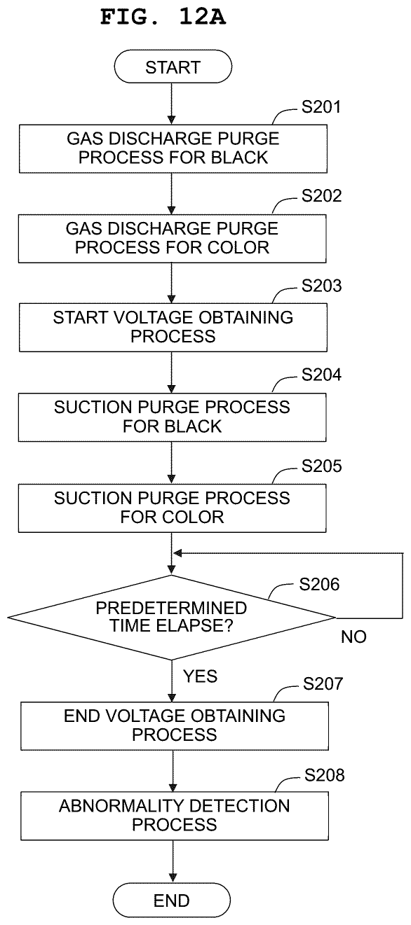

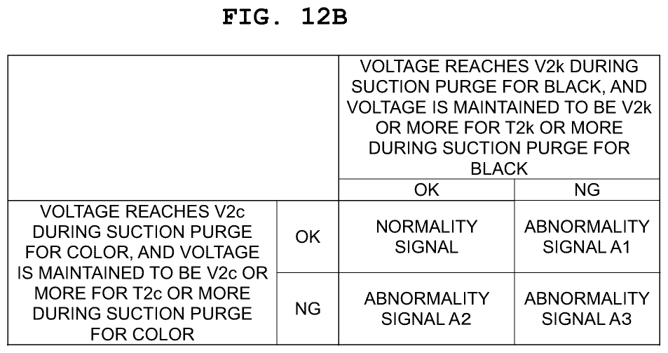

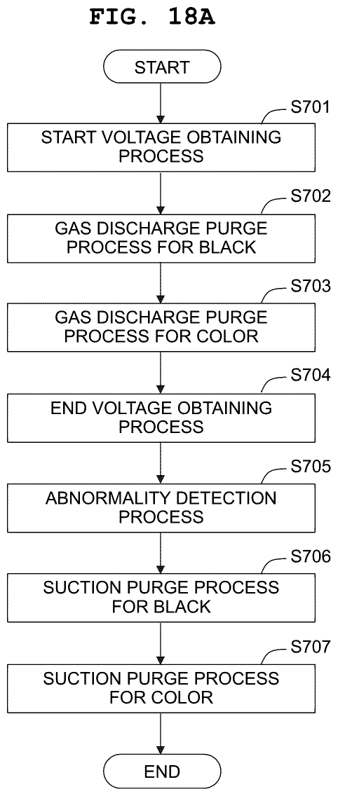

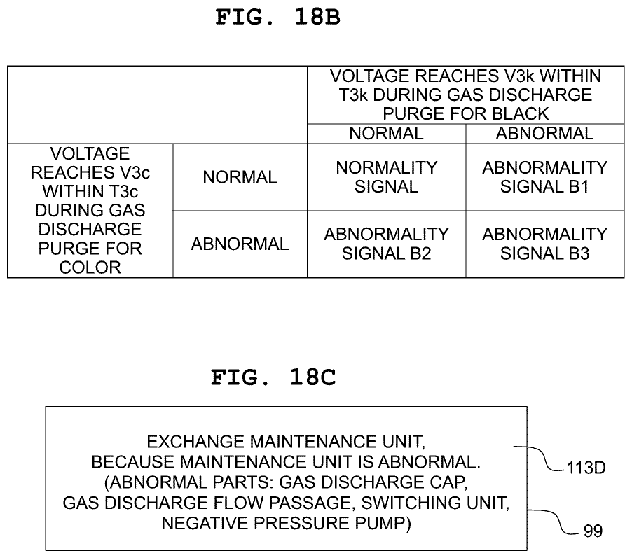

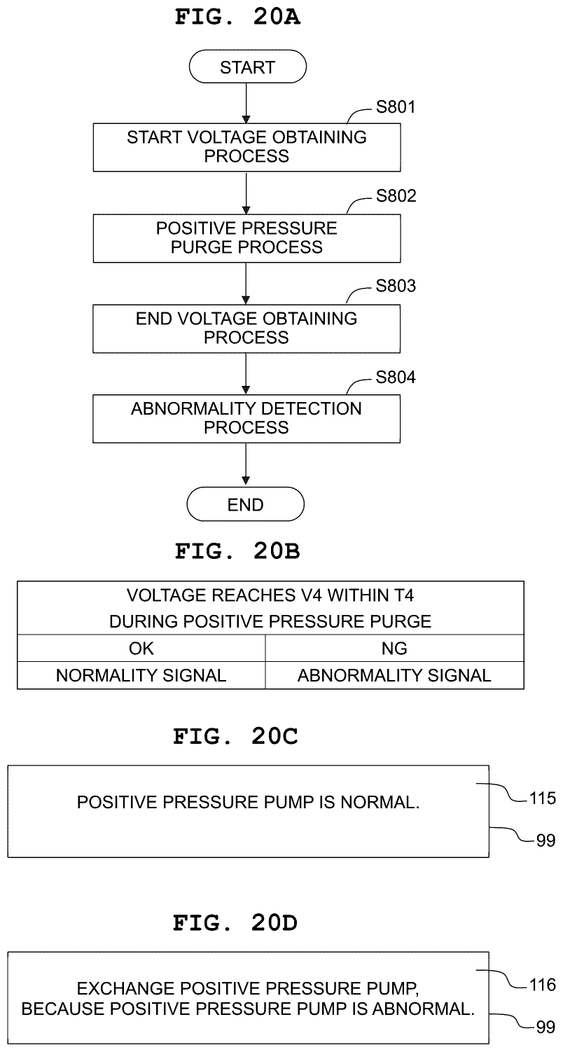

Note that in the present embodiment, the condition, in which the voltage of the piezoelectric element 50 reaches the voltage V1k within the time T1k after the start of the suction purge for the black, corresponds to the “a liquid discharge-voltage condition” and the “first liquid discharge-voltage condition” of the present disclosure. Further, the condition, in which the voltage of the piezoelectric element 50 reaches the voltage V1c within the time T1c after the start of the suction purge for the color, corresponds to the “liquid discharge-voltage condition” and the “second liquid discharge-voltage condition” of the present disclosure. The liquid discharge-voltage condition is a voltage condition during the liquid discharge. Furthermore, the voltages V1k, V1c correspond to the “predetermined voltage” of the present disclosure. Moreover, the times T1k, T2k correspond to the “first time” of the present disclosure. Further, in FIG. 11B, the case, in which the condition is satisfied, is indicated by “OK”, and the case, in which the condition is not satisfied, is indicated by “NG” regarding the respective conditions. FIG. 12B, FIG. 18B, and FIG. 20B described later are also depicted in the same manner as described above.

Further, in a case where the voltage of the piezoelectric element 50 does not reach V1k within the time T1k after the start of the suction purge for the black and the voltage of the piezoelectric element 50 reaches V1c within the time T1c after the start of the suction purge for the color, the controller 100 outputs an abnormality signal A1 to the operation panel 99. By doing so, as depicted in FIG. 11D, the controller 100 causes the operation panel 99 to display an abnormality screen 112A which indicates that at least any one of the first nozzle cap 81a, the switching unit 84, and the liquid discharge flow passage for the black of the maintenance unit 8 is abnormal. In this context, the liquid discharge flow passage for the black refers to the flow passage such as the tube 19a or the like through which the black ink flows during the suction purge for the black and the color ink does not flow during the suction purge for the color.

Furthermore, the phrase that the first nozzle cap 81a is abnormal means, for example, that the first nozzle cap 81a has any crack and/or the first nozzle cap 81a is clogged up with any foreign matter such as paper powder or a broken piece of the recording sheet S. Moreover, the phrase that the switching unit 84 is abnormal means, for example, that the switching by the switching unit 84 is not performed normally, any inflow of the gas arises from any distinct flow passage such as a gas flow passage or the like on account of the shortage of internal grease, and/or the flow passage is closed by the solidified ink and/or any foreign matter. Further, the phrase that the liquid discharge flow passage for the black is abnormal means, for example, that the flow passage in the tube 19a is closed, the connecting portion of the tube 19a is cracked, and/or the tube 19a is disengaged, for example, because the tube 19a is bent and broken and/or the tube 19a is clogged up with the solidified ink or any foreign matter. In any case other than those caused by the factors described above, any factor which exerts any influence on the change in the suction pressure upon the execution of the suction purge is considered to be the abnormality, including, for example, the abnormality which is relevant to the blockade of the system subjected to the application of the pressure and the abnormality which inhibits the increase in pressure on account of the inflow of the gas.

Further, in a case where the voltage of the piezoelectric element 50 reaches V1k within the time T1k after the start of the suction purge for the black and the voltage of the piezoelectric element 50 does not reach V1c within the time T1c after the start of the suction purge for the color, the controller 100 outputs an abnormality signal A2 to the operation panel 99. By doing so, as depicted in FIG. 11E, the controller 100 causes the operation panel 99 to display an abnormality screen 112B which indicates that at least any one of the second nozzle cap 81b, the switching unit 84, and the liquid discharge flow passage for the color of the maintenance unit 8 is abnormal. In this context, the liquid discharge flow passage for the color refers to the flow passage such as the tube 19b or the like through which the black ink does not flow during the suction purge for the black and the color ink flows during the suction purge for the color.

Furthermore, the phrase that the second nozzle cap 81b is abnormal means, for example, that the second nozzle cap 81b has any crack and/or the second nozzle cap 81b is clogged up with any foreign matter such as paper powder or broken pieces of the recording sheet S. Moreover, the phrase that the liquid discharge flow passage for the color is abnormal means, for example, that the flow passage in the tube 19b is closed, the connecting portion of the tube 19b is cracked, and/or the tube 19b is disengaged, for example, because the tube 19b is bent and broken and/or the tube 19b is clogged up with the solidified ink or any foreign matter. In any case other than those caused by the factors described above, a factor which exerts any influence on the change in the suction pressure upon the execution of the suction purge is considered to be the abnormality, including, for example, the abnormality which is relevant to the blockade of the system subjected to the application of the pressure and the abnormality which inhibits the increase in pressure on account of the inflow of the gas.

Further, in a case where the voltage of the piezoelectric element 50 does not reach V1k within the time T1k after the start of the suction purge for the black and the voltage of the piezoelectric element 50 does not reach V1c within the time T1c after the start of the suction purge for the color, the controller 100 outputs an abnormality signal A3 to the operation panel 99. By doing so, as depicted in FIG. 11F, the controller 100 causes the operation panel 99 to display an abnormality screen 112C which indicates that at least any one of the switching unit 84, the negative pressure pump 83, and the common liquid discharge flow passage of the maintenance unit 8 is abnormal. In this context, the common liquid discharge flow passage refers to the flow passage such as the tube 19d or the like through which the black ink flows during the suction purge for the black and the color ink flows during the suction purge for the color.

Furthermore, the phrase that the negative pressure pump 83 is abnormal means, for example, that the pump motor 83a is not driven normally, for example, because the wiring of the pump motor 83a undergoes breaking of wire or is rusted, or a roller of a tube pump is damaged or a tube is deteriorated to cause the leakage of air in a case where the negative pressure pump 83 is the tube pump. Moreover, the phrase that the common liquid discharge flow passage is abnormal means, for example, that the flow passage in the tube 19d is closed, the connecting portion of the tube 19d is cracked, and/or the tube 19d is disengaged, for example, because the tube 19d is bent and broken and/or the tube 19d is clogged up with the solidified ink or any foreign matter. In any case other than the contents described above, a factor which exerts any influence on the change in the suction pressure upon the execution of the suction purge is considered to be the abnormality, including, for example, the abnormality which is relevant to the blockade of the system subjected to the application of the pressure and the abnormality which inhibits the increase in pressure on account of the inflow of the gas.

### Technical Effects

In this context, in a case where the suction purge for the black is performed normally, the pressure in each of the pressure chambers 41 corresponding to one of the nozzles 40 from which the black ink is (to be) ejected is negative pressure. Accordingly, the piezoelectric element 50, which forms the wall of each of the pressure chambers 41, is deformed. Further, the voltage is generated in the piezoelectric layer 52 on account of the deformation of the piezoelectric element 50 described above. In the present embodiment, the common electrode 53 is retained at the ground electric potential. Therefore, the voltage of the individual electrode 54 is the voltage generated in the piezoelectric element 50. Therefore, the voltage of the piezoelectric element 50 can be obtained by obtaining the voltage of the individual electrode 54. Further, the voltage of the piezoelectric element 50 reaches the voltage V1k within the time T1k after the start of the suction purge for the black. On the other hand, in a case where the suction purge for the black is not performed normally, the deformation of the piezoelectric element 50 described above is small, or the deformation of the piezoelectric element 50 described above is moderate. On this account, in this situation, the voltage of the piezoelectric element 50 does not reach the voltage V1k in some cases, and the time, which is required until the voltage of the piezoelectric element 50 reaches the voltage V1k after the start of the suction purge for the black, exceeds the time T1k in other cases.

Similarly, in a case where the suction purge for the color is performed normally, the pressure in each of the pressure chambers 41 corresponding to one of the nozzles 40 from which the color inks are (to be) ejected is negative pressure. Accordingly, the piezoelectric element 50, which forms the wall of each of the pressure chambers 41, is deformed, and the voltage is generated in the piezoelectric element 50. Further, the voltage of the piezoelectric element 50 reaches the voltage V1c within the time T1c after the start of the suction purge for the color. On the other hand, in a case where the suction purge for the color is not performed normally, the voltage of the piezoelectric element 50 does not reach the voltage V1c in some cases, and the time, which is required until the voltage of the piezoelectric element 50 reaches the voltage V1c after the start of the suction purge for the color, exceeds the time T1c in other cases.

In view of the above, in the present embodiment, the controller 100 outputs the abnormality signal, which indicates that at least a part of the maintenance unit 8 is abnormal in a case where the voltage of the piezoelectric element 50 does not reach the voltage V1k within the time T1k after the start of the suction purge for the black and in a case where the voltage of the piezoelectric element 50 does not reach the voltage V1c within the time T1c after the start of the suction purge for the color. With this, the existence of the abnormality can be detected by the simple configuration regarding at least any one of a part of the maintenance unit 8 including the negative pressure pump 83, i.e., the maintenance unit 8 as a whole, the first and second nozzle caps 81a, 81b, the negative pressure pump 83, the switching unit 84, and the tubes 19a to 19d.

Further, in this context, in a case where the voltage of the piezoelectric element 50 does not reach the voltage V1k within the time T1k after the start of the suction purge for the black and in a case where the voltage of the piezoelectric element 50 reaches the voltage V1c within the time T1c after the start of the suction purge for the color, a portion of the maintenance unit 8 relevant to the suction purge for the black is highly likely to be abnormal. In view of the above, in the present embodiment, the controller 100 outputs the abnormality signal A1 in this case, which indicates that at least any one of the first nozzle cap 81a, the liquid discharge flow passage for the black, and the switching unit 84 of the maintenance unit 8 relevant to the suction purge for the black is abnormal.

On the other hand, in a case where the voltage of the piezoelectric element 50 reaches the voltage V1k within the time T1k after the start of the suction purge for the black and in a case where the voltage of the piezoelectric element 50 does not reach the voltage V1c within the time T1c after the start of the suction purge for the color, a portion of the maintenance unit 8 relevant to the suction purge for the color is highly likely to be abnormal. In view of the above, in the present embodiment, the controller 100 outputs the abnormality signal A2 in this case, which indicates that at least any one of the second nozzle cap 81b, the liquid discharge flow passage for the color, and the switching unit 84 of the maintenance unit 8 relevant to the suction purge for the color is abnormal.

Further, the abnormality is less likely to occur simultaneously in a portion of the maintenance unit 8 relating to the suction purge for the black and not relating to the suction purge for the color and a portion relating to the suction purge for the color and not relating to the suction purge for the black. Therefore, in a case where the voltage of the piezoelectric element 50 does not reach the voltage V1k within the time T1k after the start of the suction purge for the black and in a case where the voltage of the piezoelectric element 50 does not reach the voltage V1c within the time T1c after the start of the suction purge for the color, a portion of the maintenance unit 8 relating to both of the suction purge for the black and the suction purge for the color is highly likely to be abnormal. In view of the above, in the present embodiment, the controller 100 outputs the abnormality signal A3 in this case, which indicates that at least any one of the switching unit 84, the negative pressure pump 83, and the common liquid discharge flow passage relevant to both of the suction purge for the black and the suction purge for the color is abnormal.

Further, in the present embodiment, the existence of the abnormality in at least a part of the maintenance unit 8 is indicated by outputting any one of the abnormality signals A1 to A3. Further, any one of the abnormality screens 112A to 112C is displayed on the operation panel 99, which prompts the exchange of at least a part of the maintenance unit 8. Accordingly, the user can grasp that at least a part of the maintenance unit 8 is preferably exchanged.

Further, in the present embodiment, in a case where the voltage of the piezoelectric element 50 reaches the voltage V1k within the time T1k after the start of the suction purge for the black and in a case where the voltage of the piezoelectric element 50 reaches the voltage V1c within the time T1c after the start of the suction purge for the color, the maintenance unit 8 is highly likely to normal. In view of the above, in the present embodiment, the controller 100 outputs the normality signal, which indicates that the maintenance unit 8 is normal, in this case, and the controller 100 causes the operation panel 99 to display the normality screen 111 which indicates that the maintenance unit 8 is normal. Accordingly, the user can grasp that the maintenance unit 8 is normal.

Further, in the printer 1, in a case where the user performs, on the operation panel 99, the operation to instruct the printer 1 to perform the cleaning, the recording result on the recording sheet S involves any problem in many cases. On the other hand, in a case where the recording on the recording sheet S involves any problem, the ink might be not discharged sufficiently in the suction purge which has been performed before the recording on the recording sheet S, due to the abnormality existing in at least a part of the maintenance unit 8.

In view of the above, in the present embodiment, in a case where the operation panel 99 transmits the cleaning instruction signal in accordance with the operation performed by the user on the operation panel 99 and where the controller 100 receives the cleaning instruction, the controller 100 executes the process for detecting whether the maintenance unit 8 is abnormal.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification

In the embodiment described above, the controller 100 outputs the signal in the abnormality detection process depending on whether the voltage of the piezoelectric element 50 reaches V1k within the time T1k after the start of the suction purge for the black and whether the voltage of the piezoelectric element 50 reaches V1c within the time T1c after the start of the suction purge for the color. However, the present disclosure is not limited to this.

For example, the controller 100 may output a signal in the abnormality detection process depending on whether the voltage of the piezoelectric element 50 obtained by the voltage obtaining process reaches V1k during the suction purge for the black irrelevant to the time after the start of the suction purge for the black and whether the voltage of the piezoelectric element 50 obtained by the voltage obtaining process reaches V1c during the suction purge for the color irrelevant to the time after the start of the suction purge for the color. Note that in this case, the condition, in which the voltage of the piezoelectric element 50 obtained by the voltage obtaining process reaches the voltage V1k during the suction purge for the black, corresponds to the “liquid discharge-voltage condition” and the “first liquid discharge-voltage condition” of the present disclosure. Further, the condition, in which the voltage of the piezoelectric element 50 obtained by the voltage obtaining process reaches the voltage V1c during the suction purge for the color, corresponds to the “liquid discharge-voltage condition” and the “second liquid discharge-voltage condition” of the present disclosure.

Further, a signal, which depends on the voltage of the piezoelectric element 50 during the suction purge and after the suction purge, may be outputted in the abnormality detection process. For example, in a first modification, in a case where the cleaning instruction signal is received, the controller 100 performs the process in accordance with a flow chart indicated in FIG. 12A.

The process will be described in detail below. The controller 100 executes processes of S201 to S205 in a similar manner to the processes of S101 to S105 of the embodiment described above. Further, after the completion of the suction purge for the color, the controller 100 continues the voltage obtaining process until a predetermined time elapses (S206: NO). In this context, the predetermined time is set to such a time that a time T2k elapses after the completion of the suction purge for the black and a time T2c elapses after the completion of the suction purge for the color at a point in time at which the predetermined time elapses after the completion of the suction purge for the color. In this context, the time T2k and the time T2c may be times having an identical length, or the time T2k and the time T2c may be times having different lengths.

After the completion of the suction purge for the color, in a case where the predetermined time elapses (S206: YES), the controller 100 executes processes of S207, S208 in the same manner as the processes of S106, S107 of the embodiment described above.

Note, however, that in the abnormality detection process of S208, as depicted in FIG. 12B, the controller 100 outputs the normality signal so as to cause the operation panel 99 to display the normality screen 111 depicted in FIG. 11C in a case where the voltage of the piezoelectric element 50, which is obtained in the voltage obtaining process and which corresponds to the nozzles 40 from which the black ink is (to be) ejected, reaches a voltage V2k during the suction purge for the black, the voltage being maintained at the voltage V2k or more, for a time T2k or more after the completion of the suction purge for the black, and where the voltage of the piezoelectric element 50, which corresponds to the nozzles 40 from which the color inks are (to be) ejected, reaches a voltage V2c during the suction purge for the color, the voltage being maintained at the voltage V2c or more for a time T2c or more after the completion of the suction purge for the color. In this context, the voltage V2k may be the same as the voltage V1k of the embodiment described above, or the voltage V2k may be different from the voltage V1k. Further, the voltage V2c may be the same as the voltage V1c of the embodiment described above, or the voltage V2c may be different from the voltage V1c.

Further, in the abnormality detection process of S208, the controller 100 outputs the abnormality signal A1 so as to cause the operation panel 99 to display the abnormality screen 112A depicted in FIG. 11D in a case where the voltage of the piezoelectric element 50, which corresponds to the nozzles 40 from which the black ink is (to be) ejected, does not reach the voltage V2k during the suction purge for the black, or where the voltage reaches the voltage V2k during the suction purge for the black, the voltage being nevertheless not maintained at the voltage V2k or more for the time T2k or more after the completion of the suction purge for the black, and the voltage of the piezoelectric element 50, which corresponds to the nozzles 40 from which the color inks are (to be) ejected, reaches the voltage V2c during the suction purge for the color, the voltage being maintained at the voltage V2c or more for the time T2c or more after the completion of the suction purge for the color.

Furthermore, in the abnormality detection process of S208, the controller 100 outputs the abnormality signal A2 so as to cause the operation panel 99 to display the abnormality screen 112B depicted in FIG. 11E in a case where the voltage of the piezoelectric element 50, which corresponds to the nozzles 40 from which the black ink is (to be) ejected, reaches the voltage V2k during the suction purge for the black, the voltage being maintained at the voltage V2k or more for the time T2k or more after the completion of the suction purge for the black, and the voltage of the piezoelectric element 50, which corresponds to the nozzles 40 from which the color inks are (to be) ejected, does not reach the voltage V2c during the suction purge for the color, or the voltage reaches the volta V2c during the suction purge for the color, the voltage being nevertheless not maintained at the voltage V2c or more for the time T2c or more after the completion of the suction purge for the color.

Moreover, in the abnormality detection process of S208, the controller 100 outputs the abnormality signal A3 so as to cause the operation panel 99 to display the abnormality screen 112C depicted in FIG. 11F in a case where the voltage of the piezoelectric element 50, which corresponds to the nozzles 40 from which the black ink is (to be) ejected, does not reach the voltage V2k during the suction purge for the black, or the voltage reaches the voltage V2k during the suction purge for the black, the voltage being nevertheless not maintained at the voltage V2k or more for the time T2k or more after the completion of the suction purge for the black, and the voltage of the piezoelectric element 50, which corresponds to the nozzles 40 from which the color inks are (to be) ejected, does not reach the voltage V2c during the suction purge for the color, or the voltage reaches the volta V2c during the suction purge for the color, the voltage being nevertheless not maintained at the voltage V2c or more for the time T2c or more after the completion of the suction purge for the color.

Note that in the first modification, the condition, in which the voltage of the piezoelectric element 50 corresponding to the nozzles 40 from which the black ink is (to be) ejected reaches the voltage V2k during the suction purge for the black, and the voltage is maintained at the voltage V2k or more for the time T2k or more after the completion of the suction purge for the black, corresponds to the “liquid discharge-voltage condition” and the “first liquid discharge-voltage condition” of the present disclosure. Further, the condition, in which the voltage of the piezoelectric element 50 corresponding to the nozzles 40 from which the color inks are to be) ejected reaches the voltage V2c during the suction purge for the color, and the voltage is maintained at the voltage V2c or more for the time T2c or more after the completion of the suction purge for the color, corresponds to the “liquid discharge-voltage condition” and the “second liquid discharge-voltage condition” of the present disclosure. Furthermore, the voltages V2k and V2c correspond to the “predetermined voltage” of the present disclosure. Moreover, the times T2k and T2c correspond to the “second time” of the present disclosure.

In a case where the maintenance unit 8 is normal, the negative pressure of the flow passage in the ink-jet head 4 is maintained for a while, and the voltage generated in the piezoelectric element 50 is maintained even in a case where the negative pressure pump 83 is stopped after the suction purge. On the contrary, in a case where at least a part of the maintenance unit 8 is abnormal, the following situation arises in some cases. That is, the negative pressure of the head flow passage is hardly maintained, and the voltage of the piezoelectric element 50 immediately lowers in a case where the negative pressure pump 83 is stopped after the suction purge.

In view of the above, in the first modification, the voltage of the piezoelectric element 50 is obtained during the suction purge and after the suction purge, regarding the suction purge for the black and the suction purge for the color, by the voltage obtaining process. Further, the controller 100 outputs the abnormality signal, which indicates that at least a part of the maintenance unit 8 is abnormal, in a case where the voltage of the piezoelectric element 50 does not reach the voltage V2k during the suction purge for the black, or the voltage of the piezoelectric element 50 reaches the voltage V2k during the suction purge for the black but the voltage of the piezoelectric element 50 is not maintained at V2k or more for the time T2k or more after the suction purge for the black. Furthermore, the controller 100 outputs the abnormality signal, which indicates that at least a part of the maintenance unit 8 is abnormal, in a case where the voltage of the piezoelectric element 50 does not reach the voltage V2c during the suction purge for the color, or the voltage of the piezoelectric element 50 reaches the voltage V2c during the suction purge for the color but the voltage of the piezoelectric element 50 is not maintained at V2c or more for the time T2c or more after the suction purge for the color. Accordingly, the existence of the abnormality in at least a part of the maintenance unit 8 including the negative pressure pump 83 can be detected by the simple configuration.

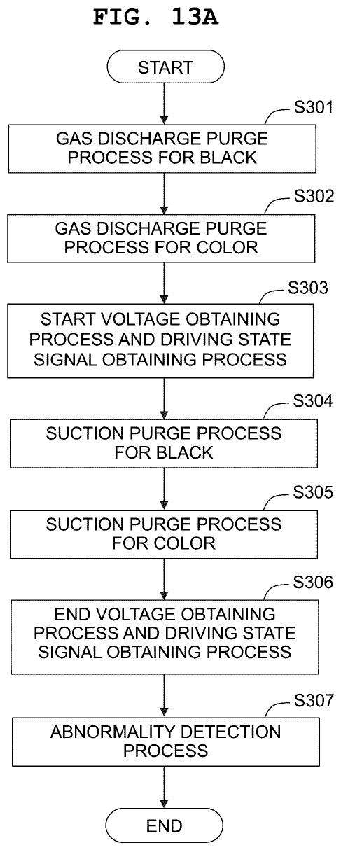

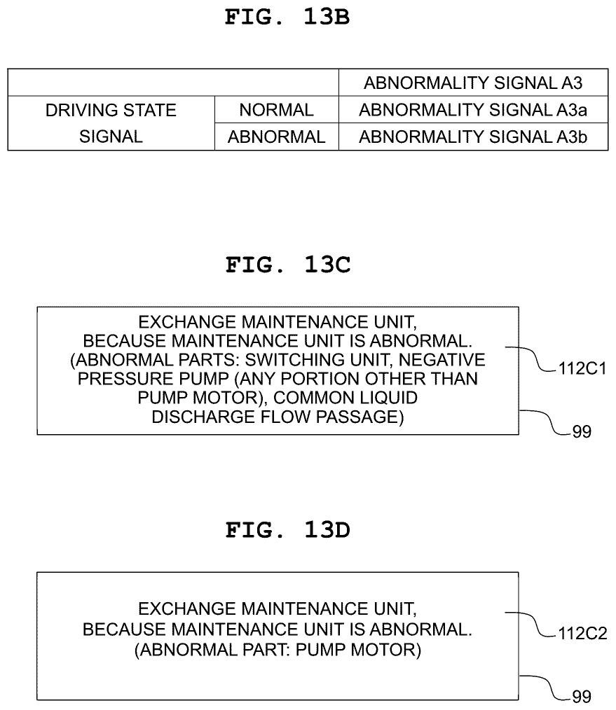

Alternatively, in a case where the pump motor 83a of the negative pressure pump 83 outputs a driving state signal which indicates the driving state of the pump motor 83a itself, a signal may be outputted in the abnormality detection process, which depends on the change in the voltage of the piezoelectric element 50 and the driving state signal. For example, in a second modification, the pump motor 83a of the negative pressure pump 83 outputs the driving state signal which indicates the driving state of the pump motor 83a itself as described above. Further, in the second modification, in a case where the cleaning instruction signal is received, the controller 100 performs the process in accordance with a flow chart indicated in FIG. 13A.

The process will be described in detail below. The controller 100 executes processes of S301, S302 in the same manner as the processes of S101, S102 of the embodiment described above. Subsequently, the controller 100 starts a voltage obtaining process and a driving state signal obtaining process (S303). The voltage obtaining process is the same as or equivalent to the voltage obtaining process described in the foregoing embodiment. In the driving state signal obtaining process, the controller 100 obtains the driving state signal outputted from the pump motor 83a.

Subsequently, the controller 100 executes processes of S304, S305 in the same manner as the processes of S104, S105 of the embodiment described above. Subsequently, the controller 100 ends the voltage obtaining process and the driving state signal obtaining process (S306), and the controller 100 executes an abnormality detection process (S307) in the same manner as the process of S107 of the embodiment described above.

In the abnormality detection process of S307, the controller 100 outputs the normality signal, the abnormality signal A1, the abnormality signal A2, and the abnormality signal A3 based on the change in the voltage of the piezoelectric element 50 obtained by the voltage obtaining process during the suction purge for the black and the change in the voltage of the piezoelectric element 50 obtained by the voltage obtaining process during the suction purge for the color, as obtained by the voltage obtaining process, in the same manner as described in the foregoing embodiment.

Note, however, that in the abnormality detection process of S307, the process differs from the process of the embodiment described above in a case where the abnormality signal S3 is outputted. As depicted in FIG. 13B, in a case where the driving state signal, which is obtained by the driving state signal obtaining process, indicates that the pump motor 83a is driven normally, the controller 100 outputs an abnormality signal A3a as the abnormality signal A3 so as to cause the operation panel 99 to display an abnormality screen 112C1 which indicates that any one of the switching unit 84, any portion other than the pump motor 83a of the negative pressure pump 83, and the common liquid discharge flow passage of the maintenance unit 8 is abnormal as depicted in FIG. 13C. In this context, the existence of the abnormality in any portion other than the pump motor 83a of the negative pressure pump 83 is, for example, a case in which the flow passage in the negative pressure pump 83 is clogged with any foreign matter, and the ink or the air in the negative pressure pump 83 does not flow normally although the pump motor 83a is driven normally, and/or a case in which the air leaks due to the deterioration of the tube of the negative pressure pump 83, and the ink or the air in the negative pressure pump 83 does not flow normally although the pump motor 83a is driven normally. Note that in the second modification, the condition, in which the driving state signal indicates that the pump motor 83a is driven normally, corresponds to the “driving signal condition” of the present disclosure.

Further, in the abnormality detection process of S307, in a case where the controller 100 outputs the abnormality signal A3, the controller 100 outputs an abnormality signal A3b as the abnormality signal A3 in a case where the driving state signal, which is obtained by the driving state signal obtaining process during the suction purge processes of S304, S305, indicates that the pump motor 83a is not driven normally. By doing so, as depicted in FIG. 13D, the controller 100 causes the operation panel 99 to display an abnormality screen 112C2, which indicates that the pump motor 83a of the maintenance unit 8 is abnormal, is displayed on the operation panel 99.

In this context, in a case where the pump motor 83a is abnormal, the driving state signal, which is obtained by the driving state signal obtaining process in any case of the suction purge for the black and the suction purge for the color, usually indicates that the pump motor 83a is not driven normally. In view of the above, in the abnormality detection process of S307, for example, in a case where at least one driving state signal, which is included in the driving state signals obtained by the driving state signal obtaining process during the suction purge for the black and the suction purge for the color, indicates that the pump motor 83a is not driven normally, the controller 100 determines that the driving state signal indicates that the pump motor 83a is not driven normally. Alternatively, for example, in a case where both of the driving state signals, which are obtained by the driving state signal obtaining processes during the suction purge for the black and the suction purge for the color, indicate that the pump motor 83a is not driven normally, the controller 100 determines that the driving state signal indicates that the pump motor 83a is not driven normally.

In the second modification, in a case where the voltage of the piezoelectric element 50 does not reach the voltage V1k within the time T1k after the start of the suction purge for the black and the voltage of the piezoelectric element 50 does not reach the voltage V1c within the time T1c after the start of the suction purge for the color, the controller 110 outputs any one of the abnormality signal A3a which indicates that at least any one of the switching unit 84, any portion of the negative pressure pump 83 other than the pump motor 83a, and the common liquid discharge flow passage is abnormal and the abnormality signal A3b which indicates that the pump motor 83a is abnormal, as the abnormality signal A3 depending on whether the driving state signal indicates that the pump motor 83a is driven normally. Accordingly, the controller 100 can distinguish and detect the abnormality existing in the pump motor 83a and the abnormality existing in at least any one of the switching unit 84, any portion of the negative pressure pump 83 other than the pump motor 83a, and the common liquid discharge flow passage.

Further, in the second modification, in place of the procedure described above, in a case where the driving state signal indicates that the pump motor 83a is driven normally, the control 100 may output an abnormality signal which indicates that any one of the switching unit 84 and the tube 19c is abnormal, as the abnormality signal A3. Further, in a case where the driving state signal indicates that the pump motor 83a is abnormal, the controller 100 may output an abnormality signal which indicates that the negative pressure pump 83 is abnormal, as the abnormality signal A3.

Further, in the embodiment described above, in a case where the cleaning instruction signal is received, the controller 100 executes the process to determine whether the maintenance unit 8 is abnormal. However, the present disclosure is not limited to this.

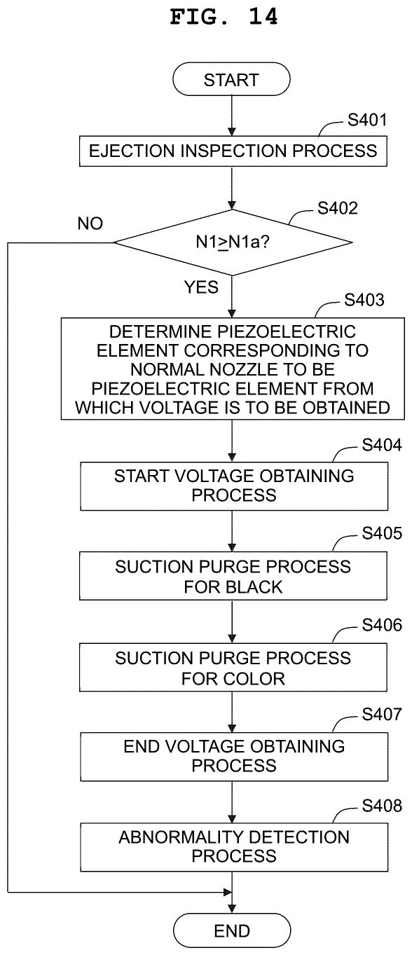

In a third modification, the controller 100 performs the process in accordance with a flow chart indicated in FIG. 14 in a case where an inspection instruction signal, which instructs the controller 100 to perform the instruction of the plurality of nozzles 40 of the ink-jet head 4, is received. For example, in a case where the operation for instructing the controller 100 to perform the inspection of the nozzles 40 is performed by the user on the operation panel 99, the operation panel 99 transmits the inspection instruction signal, and the controller 100 receives the inspection instruction signal. Alternatively, for example, in a case where a previously set time comes, the controller 100 receives the inspection instruction signal.

The flow chart indicated in FIG. 14 will be described in detail below. In a case where the controller 100 receives the inspection instruction signal, the controller 100 firstly executes an ejection inspection process (S401). In the ejection inspection process, the controller 100 controls, for example, the carriage motor 106 and the cap lifting mechanism 109 so as to provide the capped state as described above. The controller 100 controls the high voltage power source circuit 92 to apply the predetermined voltage to the electrode 91. After that, the controller 100 controls the driver IC 108 to perform the driving for inspection with respect to each of the plurality of nozzles 40 of the ink-jet head 4. Further, the controller 100 causes the memory 104 to store the ejection inspection information regarding whether the nozzles 40 are abnormal nozzles, based on the signal outputted from the signal processing circuit 93 during the driving for inspection with respect to each of the nozzles 40.

Subsequently, the controller 100 determines whether a number N1 of abnormal nozzles is a predetermined number N1a or more, based on the ejection inspection information stored in the memory 104 (S402). In this context, the predetermined number N1a may be one, or the predetermined number N1a may be two or more.

In a case where the number N1 of abnormal nozzles is less than the predetermined number N1a (S402: NO), the process is ended. In a case where the number N1 of abnormal nozzles is the predetermined number N1a or more (S402: YES), the controller 100 determines the piezoelectric element 50 corresponding to any normal nozzle which is not the abnormal nozzle of the nozzles 40 from which the black ink is (to be) ejected and the piezoelectric element 50 corresponding to any normal nozzle which is not the abnormal nozzle of the nozzles 40 from which the color ink is (to be) ejected to be the piezoelectric element 50 from which the voltage is obtained in the voltage obtaining process (S403). Subsequently, the controller 100 executes processes of S404 to S408 in the same manner as the processes of S101 to S105 of the embodiment described above. Further, in the voltage obtaining process which starts in S404, the controller 100 obtains the voltage of the piezoelectric element 50 determined in S403.

In a case where the abnormal nozzle is absent and, in a case where the number of abnormal nozzles is small, the maintenance unit 8 is highly likely to be normal, the ink is highly likely to be sufficiently discharged by the suction purge having been performed until that time, and the abnormal nozzles are highly likely to have been recovered. On the other hand, in a case where the number of abnormal nozzles is large, at least a part of the maintenance unit 8 is likely to be abnormal, and hence the ink is less likely to be sufficiently discharged by the suction purge having been performed until that time.

In view of the above, in the third modification, in a case where the number N1 of abnormal nozzles is the predetermined number N1a or more, the controller 100 performs the suction purge for the black and the suction purge for the color, and obtains the voltage of the piezoelectric element 50 during each of the suction purge processes. Further, the controller 100 executes the abnormality detection process based on the obtained voltage. Accordingly, in a case where the maintenance unit 8 is normal, the abnormal nozzles can be recovered by the suction purge. In a case where at least a part of the maintenance unit is abnormal, the abnormality can be detected.

Further, in the third modification, the controller 100 obtains the voltage of the piezoelectric element 50, which corresponds to any normal nozzle that is not the abnormal nozzle of the nozzles 40 from which the black and color inks are (to be) ejected, respectively during the suction purge for the black and the suction purge for the color. Accordingly, for example, at least a part of the maintenance unit 8 can be prevented from being determined erroneously to be abnormal, based on the voltage of the piezoelectric element 50 having the abnormality.

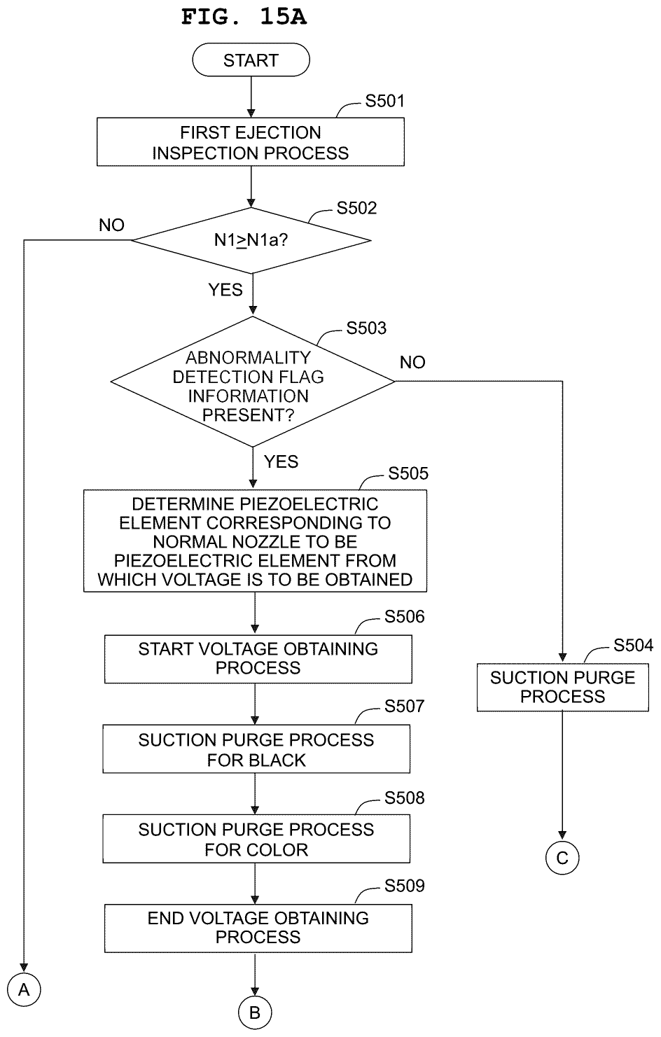

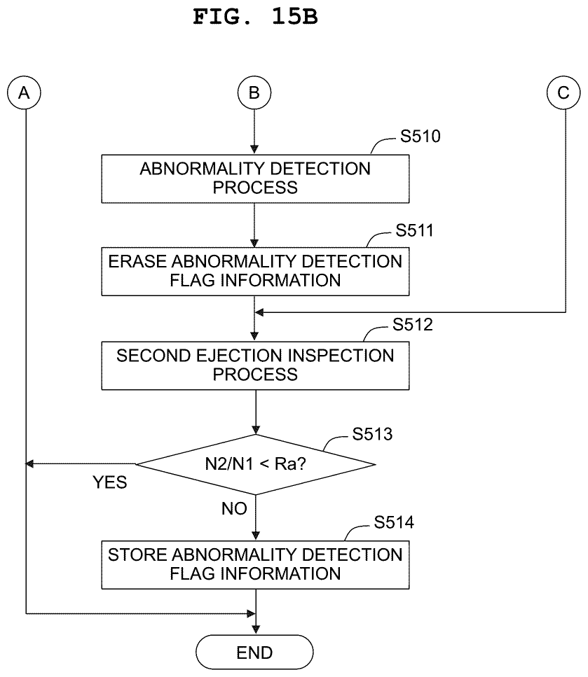

In a fourth modification, in a case where the controller 100 receives the inspection instruction signal, the controller 100 performs the process in accordance with a flow chart shown in FIGS. 15A and 15B. The process will be described in detail below. Upon receiving the inspection instruction signal, the controller 100 executes a first ejection inspection process in the same manner as the ejection inspection process of S401 of the third modification (S501). Further, in the first ejection inspection process, the controller 100 causes the memory 104 to store the first ejection inspection information as the ejection inspection information. Subsequently, the controller 100 determines whether the number N1 of abnormal nozzles is the predetermined number N1a or more (S502) based on the first ejection inspection information stored in the memory 104 in the same manner as S402 of the third modification. In a case where the number N1 of abnormal nozzles is less than the predetermined number N1a (S502: NO), the process is ended.

In a case where the number N1 of abnormal nozzles is the predetermined number N1 or more (S502: YES), the controller 100 subsequently determines whether the abnormality detection flag information is stored in the memory 104 (S503). The abnormality detection flag is stored in the memory 104 in S514 described later in a case where the process has been performed in accordance with the flow chart indicated in FIGS. 15A and 15B in the past.

In a case where the abnormality detection flag information is not stored in the memory 104 (S503: NO), the controller 100 executes a suction purge process (S504). In the suction purge process of S504, the controller 100 executes at least one of the purge process for the black and the purge process for the color. In particular, in a case where the first ejection inspection information indicates that any nozzle 40 from which the black is (to be) ejected is the abnormal nozzle, the controller 100 executes the purge process for the black in the purge process of S504. Further, in a case where the first ejection inspection information indicates that any nozzle 40 from which the color ink is (to be) ejected is the abnormal nozzle, the controller 100 executes the purge process for the color in the purge process of S504. Further, the process proceeds to S512 after the purge process of S504.

In a case where the abnormality detection flag information is stored in the memory 104 (S503: YES), the controller 100 executes processes of S505 to S510 in the same manner as the processes of S403 to S408 of the third modification. Subsequently, the controller 100 erases the abnormality detection flag information stored in the memory 104 (S511), and the process proceeds to S512.

In S512, the controller 100 executes a second ejection inspection process. In the second ejection inspection process, the controller 100 causes the ink-jet head 4 to perform the driving for inspection in the same manner as the first ejection inspection process regarding the nozzles 40 regarding which the memory 104 stores that the nozzles 40 are the abnormal nozzles in at least the first ejection inspection process of S501. The controller 100 causes the memory 104 to store the second ejection inspection information as the ejection inspection information.

Subsequently, the controller 100 determines whether a ratio [N2/N1] of the number N2 of abnormal nozzles indicated by the second ejection inspection information with respect to the number N1 of abnormal nozzles indicated by the first ejection inspection information is less than a predetermined ratio Ra (S513). The smaller the ratio [N2/N1] is, the higher the ratio of abnormal nozzles recovered by the suction purge of S504 or the suction purge of S507, S508 is indicated. Note that in the fourth modification, the condition, in which the ratio [N2/N1] is the predetermined ratio Ra or more, corresponds to the “difference condition” of the present disclosure.

In a case where the ratio [N2/N1] is less than the predetermined ratio Ra (S513: YES), the process is ended as it is. In a case where the ratio [N2/N1] is the predetermined ratio Ra or more (S513: NO), the controller 100 causes the memory 104 to store the abnormality detection flag information (S514), and the process is ended.

In the fourth modification, in a case where the number NI of abnormal nozzles indicated by the first ejection inspection information is the predetermined number N1a or more, and the abnormality detection flag information is stored in the memory 104, the controller 100 performs the suction purge for the black and the suction purge for the color, and obtains the voltage of the piezoelectric element 50 in each of the suction purge processes. Further, the controller 100 executes the abnormality detection process based on the obtained voltage. By doing so, in a case where the maintenance unit 8 is normal, the abnormal nozzles can be recovered by the suction purge; and in a case where at least a part of the maintenance unit is abnormal, the abnormality can be detected.

Further, in the fourth modification, the controller 100 then executes the second ejection inspection process. In this procedure, in a case where the maintenance unit 8 is normal, most of the abnormal nozzles are highly likely to be recovered by the suction purge described above, and the ratio [N2/N1] is highly likely to be small. On the other hand, in a case where at least a part of the maintenance unit 8 is abnormal, a large number of the abnormal nozzles are less likely to be recovered by the suction purge described above, and the ratio [N2/N1] is highly likely to be large.

In view of the above, in the fourth modification, in a case where the ratio [N2/N1] is the predetermined ratio Ra or more, the controller 100 causes the memory 104 to store the abnormality detection flag information. Accordingly, in a case where at least a part of the maintenance unit 8 is highly likely to be abnormal, the voltage of the piezoelectric element 50 is obtained during the suction purge to be performed next time; and whether at least a part of the maintenance unit 8 is abnormal can be detected based on the obtained voltage. On the other hand, in a case where the ratio [N2/N1] is less than the predetermined ratio Ra, the controller 100 does not cause the memory 104 to store the abnormality detection flag information. With this, in a case where the maintenance unit 8 is highly likely to be normal, the controller 100 does not perform the obtainment of the voltage of the piezoelectric element 50 and does not detect whether at least a part of the maintenance unit 8 is abnormal during the suction purge to be performed next time, thereby simplifying the process.

Further, in the fourth modification, the condition, in which the ratio [N2/N1] is the predetermined ratio Ra or more, is the difference condition. However, another condition, which relates to the difference between the number N1 of abnormal nozzles and the number N2 of the abnormal nozzles, may be the difference condition. For example, a condition, in which a value [N1-N2] obtained by subtracting the number N2 of abnormal nozzles indicated by the second ejection inspection information from the number N1 of abnormal nozzles indicated by the first ejection inspection information is less than a predetermined value, may be the difference condition.

Furthermore, in the fourth modification, the following case has been described. That is, the process is performed in accordance with the flow chart indicated in FIGS. 15A and 15B for the next suction purge after storing the abnormality detection flag information in the memory 104. The suction purge processes of S507, S508 are performed in a case where the number N1 of abnormal nozzles indicated by the first ejection inspection information in S503 is the predetermined number N1a or more. However, the present disclosure is not limited to this. The next suction purge, which is performed after storing the abnormality detection flag information in the memory 104, may be any suction purge which is performed at any timing different from the above.

Moreover, in the third and fourth modifications, the voltages of the piezoelectric elements 50, which correspond to the nozzles 40 set irrelevant to the result of the ejection inspection process for the nozzles 40 from which the black ink and the color inks are (to be) ejected, respectively, may be obtained during the suction purge for the black and the suction purge for the color in the same manner as the embodiment described above.

Further, in the embodiment described above and the first and second modifications, the voltage of the piezoelectric element 50, which corresponds to any normal nozzle that is not the abnormal nozzle, may be obtained during the suction purge for the black and the suction purge for the color. In this case, the piezoelectric element 50, which corresponds to any normal nozzle that is not the abnormal nozzle, is determined based on the result of the ejection inspection process performed before the execution of the process in accordance with the flow charts depicted in FIG. 11A, FIG. 12A, and FIG. 13.

Furthermore, the ejection inspection part 90 may be omitted in the embodiment described above and the first and second modifications in which the voltage of the piezoelectric element 50 set irrelevant to the result of the ejection inspection process is obtained during the suction purge for the black and the suction purge for the color.

Moreover, in the embodiment described above and the first and second modifications, the gas discharge purge process for the black and the gas discharge purge process for the color may be not executed in a case where the cleaning instruction signal is received. In the embodiment described above and the first and second modifications, in a case where the cleaning instruction signal is received and in a case where the gas discharge purge process for the black and the gas discharge purge process for the color are not executed, and in the third and fourth modifications, the printer 1 may not include the constitutive components for performing the gas discharge purge, including, for example, the gas discharge flow passage 66, the gas discharge unit 67, and the gas discharge cap 82.

Further, in the third and fourth modifications, in a case where the number of abnormal nozzles is especially large, the gas discharge purge process for the black and the gas discharge purge process for the color may be executed, for example, before starting the voltage obtaining process or before executing the suction purge process.

Further, in the printer such as the printer 1 of the embodiment described above in which the gas discharge purge can be performed, the existence of the abnormality in the maintenance unit 8 may be detected based on the change in the voltage of the piezoelectric element 50 during the suction purge and the change in the voltage of the piezoelectric element 50 during the gas discharge purge.

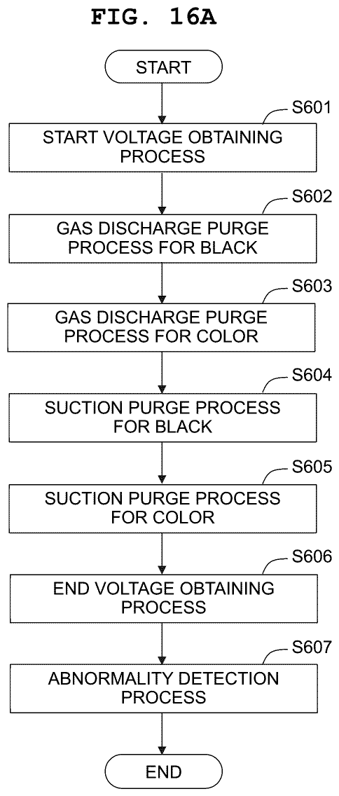

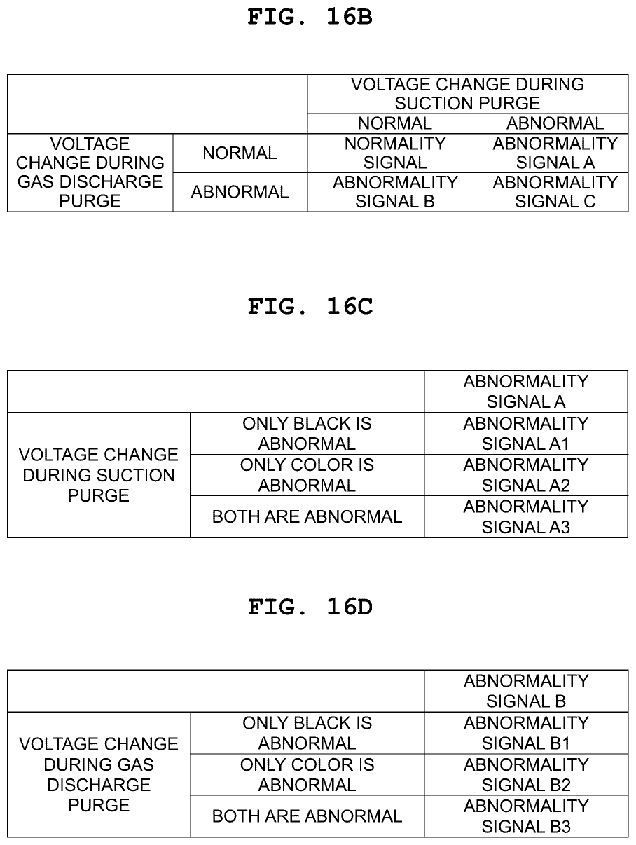

For example, in a fifth modification, in a case where the controller 100 receives the cleaning instruction signal, the controller 100 performs the process in accordance with a flow chart indicated in FIG. 16A.

The process will be described in detail below. In a case where the controller 100 receives the cleaning instruction signal, the controller 100 starts a voltage obtaining process (S601). Subsequently, the controller 100 executes processes of S602 to S605 in the same manner as the processes of S101, S102, S104, and S105 of the embodiment described above.

Further, in the voltage obtaining process started in S601, the controller 100 obtains the voltage of the piezoelectric element 50, which corresponds to any nozzle 40 from which the black ink is (to be) ejected, during the gas discharge purge for the black of S602. Further, in the voltage obtaining process started in S601, the controller 100 obtains the voltage of the piezoelectric element 50, which corresponds to any nozzle 40 from which the color ink is (to be) ejected, during the gas discharge purge for the color of S603. Note that in the fifth modification, the gas discharge purge process for the black and the gas discharge purge process for the color correspond to the “gas discharge process” of the present disclosure. Further, the processes of the voltage obtaining process, which are performed during the gas discharge purge processes for the black and the color, correspond to the “voltage obtaining process during gas discharge” of the present disclosure.

Furthermore, in the fifth modification, the processes of the voltage obtaining process started in S601, which are performed during the suction purge for the black of S604 and during the suction purge for the color of S605, are the same as or equivalent to the processes of the embodiment described above. Moreover, the processes of the voltage obtaining process, which are performed during the suction purge for the black and the suction purge for the color, correspond to the “voltage obtaining process during liquid discharge” of the present disclosure.

Subsequently, the controller 100 ends the voltage obtaining process (S606), and the controller 100 executes an abnormality detection process (S607). In the abnormality detection process of S607, as depicted in FIG. 16B, the controller 100 outputs signals depending on whether the change in the voltage of the piezoelectric element 50 obtained by the voltage obtaining process during the suction purge is abnormal and whether the change in the voltage of the piezoelectric element 50 obtained by the voltage obtaining process during the gas discharge purge is abnormal.

The procedure will be described in detail below. In the fifth modification, the phrase that the change in the voltage of the piezoelectric element 50 obtained by the voltage obtaining process during the suction purge is normal means that the voltage of the piezoelectric element 50 reaches the voltage V1k within the time T1k from the start of the suction purge for the black, and the voltage of the piezoelectric element 50 reaches the voltage V1c within the time T1c from the start of the suction purge for the color.

Further, in the fifth modification, the phrase that the change in the voltage of the piezoelectric element 50 obtained by the voltage obtaining process during the suction purge is abnormal means that the voltage of the piezoelectric element 50 does not reach the voltage V1k within the time T1k from the start of the suction purge for the black, or the voltage of the piezoelectric element 50 does not reach the voltage V1c within the time T1c from the start of the suction purge for the color.

Furthermore, in the fifth modification, the phrase that the change in the voltage of the piezoelectric element 50 obtained by the voltage obtaining process during the gas discharge purge is normal means that the voltage of the piezoelectric element 50 reaches the voltage V3k within the time T3k from the start of the gas discharge purge for the black, and the voltage of the piezoelectric element 50 reaches the voltage V3c within the time T3c from the start of the gas discharge purge for the color.

Moreover, in the fifth modification, the phrase that the change in the voltage of the piezoelectric element 50 obtained by the voltage obtaining process during the gas discharge purge is abnormal means that the voltage of the piezoelectric element 50 does not reach the voltage V3k within the time T3k from the start of the gas discharge purge for the black, or the voltage of the piezoelectric element 50 does not reach the voltage V3c within the time T3c from the start of the gas discharge purge for the color.

Note, however, that the criterion for determining whether the change in the voltage of the piezoelectric element 50 obtained by the voltage obtaining process during the suction purge is abnormal and the criterion for determining whether the change in the voltage of the piezoelectric element 50 obtained by the voltage obtaining process during the gas discharge purge is abnormal are not limited to the criteria described above. For example, whether the voltage of the piezoelectric element reaches a predetermined voltage during the suction purge and the voltage of the piezoelectric element 50 is maintained at the predetermined voltage or more for a predetermined time or more after the suction purge may be the criterion for determining whether the change in the voltage of the piezoelectric element 50 obtained by the voltage obtaining process during the suction purge is abnormal, based on the same or equivalent viewpoint as that of the first modification. Further, whether the voltage of the piezoelectric element reaches a predetermined voltage during the gas discharge purge and the voltage of the piezoelectric element 50 is maintained at the predetermined voltage or more for a predetermined time or more after the gas discharge purge may be the criterion for determining whether the change in the voltage of the piezoelectric element 50 obtained by the voltage obtaining process during the gas discharge purge is abnormal.

Further, in a case where the change in the voltage of the piezoelectric element 50 obtained by the voltage obtaining process during the suction purge is normal, and the change in the voltage of the piezoelectric element 50 obtained by the voltage obtaining process during the gas discharge purge is normal, the controller 100 outputs the normality signal so as to cause the operation panel 99 to display the normality screen 111 depicted in FIG. 11C in the same manner as the embodiment described above.

Furthermore, in a case where the change in the voltage of the piezoelectric element 50 obtained by the voltage obtaining process during the suction purge is abnormal, and the change in the voltage of the piezoelectric element 50 obtained by the voltage obtaining process during the gas discharge purge is normal, the controller 100 outputs the abnormality signal A. In this procedure, the controller 100 outputs any one of the abnormality signals A1 to A3 described in the foregoing embodiment as the abnormality signal A, depending on the situation of the abnormality of the change in the voltage of the piezoelectric element 50 obtained by the voltage obtaining process during the suction purge.

The procedure will be described in detail below. As depicted in FIG. 16C, in a case where the change in the voltage of the piezoelectric element 50 obtained by the voltage obtaining process during the suction purge for the black is abnormal, and the change in the voltage of the piezoelectric element 50 obtained by the voltage obtaining process during the suction purge for the color is normal, the controller 100 outputs the abnormality signal A1 as the abnormality signal A so as to cause the operation panel 99 to display the abnormality screen 112A depicted in FIG. 11D in the same manner as the embodiment described above.

Further, in a case where the change in the voltage of the piezoelectric element 50 obtained by the voltage obtaining process during the suction purge for the black is normal, and the change in the voltage of the piezoelectric element 50 obtained by the voltage obtaining process during the suction purge for the color is abnormal, the controller 100 outputs the abnormality signal A2 as the abnormality signal A so as to cause the operation panel 99 to display the abnormality screen 112B depicted in FIG. 11E in the same manner as the embodiment described above.

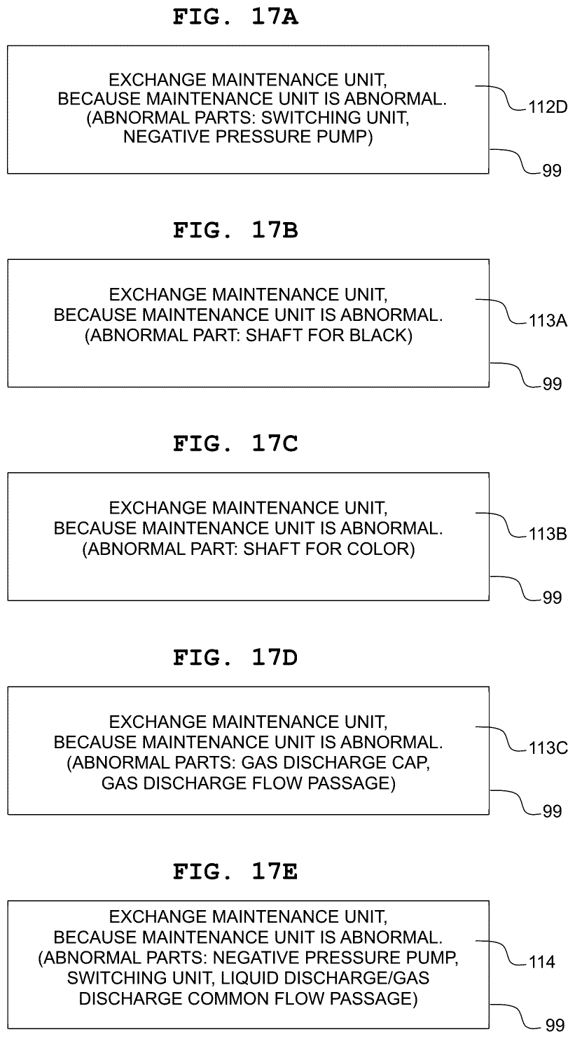

Further, in a case where the change in the voltage of the piezoelectric element 50 obtained by the voltage obtaining process during the suction purge for the black is abnormal, and the change in the voltage of the piezoelectric element 50 obtained by the voltage obtaining process during the suction purge for the color is abnormal, the controller 100 outputs the abnormality signal A3 as the abnormality signal A so as to cause the operation panel 99 to display an abnormality screen 112D which indicates that any one of the switching unit 84 and the negative pressure pump 83 of the maintenance unit 8 is abnormal as depicted in FIG. 17A.

Further, in a case where the change in the voltage of the piezoelectric element 50 obtained by the voltage obtaining process during the suction purge is normal, and the change in the voltage of the piezoelectric element 50 obtained by the voltage obtaining process during the gas discharge purge is abnormal, the controller 100 outputs an abnormality signal B. In this procedure, the controller 100 outputs any one of abnormality signals B1 to B3 as the abnormality signal B, depending on the situation of the abnormality of the change in the voltage of the piezoelectric element 50 obtained by the voltage obtaining process during the gas discharge purge.

The procedure will be described in detail below. As depicted in FIG. 16D, in a case where the change in the voltage of the piezoelectric element 50 obtained by the voltage obtaining process during the gas discharge purge for the black is abnormal, and the change in the voltage of the piezoelectric element 50 obtained by the voltage obtaining process during the gas discharge purge for the color is normal, the controller 100 outputs the abnormality signal B1 as the abnormality signal B. Accordingly, as depicted in FIG. 17B, the controller 100 causes the operation panel 99 to display an abnormality screen 113A which indicates that the shaft 86 for the black of the maintenance unit 8 is abnormal.

In this context, the shaft 86 for the black refers to the shaft 86 corresponding to the gas discharge flow passage 66 communicated with the flow passage through which the black ink flows. Further, the phrase that the shaft 86 for the black is abnormal means that the valve 68 corresponding to the shaft 86 for the black cannot be opened, for example, because the shaft 86 for the black is broken.

In a case where the change in the voltage of the piezoelectric element 50 obtained by the voltage obtaining process during the gas discharge purge for the black is normal, and the change in the voltage of the piezoelectric element 50 obtained by the voltage obtaining process during the gas discharge purge for the color is abnormal, the controller 100 outputs the abnormality signal B2 as the abnormality signal B. Accordingly, as depicted in FIG. 17C, the controller 100 causes the operation panel 99 to display an abnormality screen 113B which indicates that the shaft 86 for the color of the maintenance unit 8 is abnormal.

In this context, the shaft 86 for the color refers to the three shafts 86 corresponding to the three gas discharge flow passages 66 communicated with the flow passages through which the color inks flow. Further, the phrase that the shaft 86 for the color is abnormal means that the valve 68 corresponding to any one of the three shafts 86 for the color cannot be opened, for example, because any one of the three shafts 86 is broken.

In a case where the change in the voltage of the piezoelectric element 50 obtained by the voltage obtaining process during the gas discharge purge for the black is abnormal, and the change in the voltage of the piezoelectric element 50 obtained by the voltage obtaining process during the gas discharge purge for the color is abnormal, the controller 100 outputs the abnormality signal B3 as the abnormality signal B. By doing so, as depicted in FIG. 17D, the controller 100 causes the operation panel 99 to display an abnormality screen 113C which indicates that any one of the gas discharge cap 82 and the gas discharge flow passage of the maintenance unit 8 is abnormal. In this context, the gas discharge flow passage refers to the flow passage such as the tube 19c or the like through which the ink flows during the gas discharge purge for the black and the gas discharge purge for the color and the ink does not flow during the suction purge for the black and the suction purge for the color.

The phrase that the gas discharge cap 82 is abnormal means, for example, that the gas discharge cap 82 has any crack and/or the gas discharge cap 82 is clogged up with any foreign matter such as paper powder or a broken piece of the recording sheet S. Further, the phrase that the gas discharge flow passage is abnormal means, for example, that the flow passage in the tube 19c is closed, the connecting portion of the tube 19c is cracked, and/or the tube 19c is disengaged, for example, because the tube 19c is bent and broken and/or the tube 19c is clogged up with the solidified ink or any foreign matter. In any case other than the situations caused by the factors described above, any factor which exert any influence on the change in the suction pressure upon the execution of the suction purge are considered to be the abnormality, including, for example, the abnormality which is relevant to the blockade of the system subjected to the application of the pressure and the abnormality which inhibits the increase in pressure caused by the inflow of the gas.

In a case where the change in the voltage of the piezoelectric element 50 obtained by the voltage obtaining process during the suction purge is abnormal, and the change in the voltage of the piezoelectric element 50 obtained by the voltage obtaining process during the gas discharge purge is abnormal, the controller 100 outputs an abnormality signal C. By doing so, as depicted in FIG. 17E, the controller 100 causes the operation panel 99 to display an abnormality screen 114 which indicates that any one of the negative pressure pump 83, the switching unit 84, and the liquid discharge/gas discharge common flow passage of the maintenance unit 8 is abnormal. In this context, the liquid discharge/gas discharge common flow passage refers to the flow passage such as the tube 19d or the like through which the ink flows during any one of the suction purge and the gas discharge purge for the black and the color.

The abnormality regarding the negative pressure pump 83 and the switching unit 84 is the same as or equivalent to the abnormality described in the foregoing embodiment. The phrase that the liquid discharge/gas discharge common flow passage is abnormal means, for example, that the flow passage in the tube 19d is closed, the connecting portion of the tube 19d is cracked, and/or the tube 19d is disengaged, for example, because the tube 19d is bent and broken and/or the tube 19d is clogged up with the solidified ink or any foreign matter. In any case other than the situation caused by the contents described above, any factors which exert any influence on the change in the suction pressure upon the execution of the suction purge are considered to be the abnormality, including, for example, the abnormality which is relevant to the blockade of the system subjected to the application of the pressure and the abnormality which inhibits the increase in pressure on account of the inflow of the gas.

In this context, as described in the foregoing embodiment, in a case where the suction purge for the black is performed normally, the voltage of the piezoelectric element 50 reaches the voltage V1k within the time T1k after the start of the suction purge for the black. On the other hand, in a case where the suction purge for the black is not performed normally, the voltage of the piezoelectric element 50 does not reach the voltage V1k in some cases, and/or the time, until which the voltage of the piezoelectric element 50 after the start of the suction purge for the black reaches the voltage V1k, exceeds the time T1k in other cases.

Further, in a case where the suction purge for the color is performed normally, the voltage of the piezoelectric element 50 reaches the voltage V1c within the time T1c after the start of the suction purge for the color. On the other hand, in a case where the suction purge for the color is not performed normally, the voltage of the piezoelectric element 50 does not reach the voltage V1c in some cases, and/or the time, until which the voltage of the piezoelectric element 50 after the start of the suction purge for the color reaches the voltage V1c , exceeds the time T1c in other cases.

Further, in a case where the gas discharge purge for the black is performed normally, the pressures in the pressure chambers 41 each corresponding to one of the nozzles 40 from which the black ink is (to be) ejected have the negative pressure, and thus the voltage of each of the piezoelectric elements 50 corresponding to one of the above-described pressure chambers 41 change. Further, the voltage of each of the piezoelectric elements 50 reaches the voltage V3k within the time T3k after the start of the gas discharge purge for the black. On the other hand, in a case where the gas discharge purge for the black is not performed normally, the voltage of each of the piezoelectric elements 50 does not reach the voltage V3k in some cases, and/or the time, until which the voltage of the piezoelectric element 50 reaches the voltage V3k after the start of the gas discharge purge for the black, exceeds the time T3k in other cases.

Similarly, in a case where the gas discharge purge for the color is performed normally, the pressures in the pressure chambers 41 each corresponding to one of the nozzles 40 from which the color inks are (to be) ejected have the negative pressure, and thus the voltages of the piezoelectric elements 50 each corresponding to one of the above-described pressure chambers 41 change. Further, the voltage of each of the piezoelectric elements 50 reaches the voltage V3c within the time T3c after the start of the gas discharge purge for the color. On the other hand, in a case where the gas discharge purge for the color is not performed normally, the voltage of each of the piezoelectric elements 50 does not reach the voltage V3c in some cases, and/or the time, until which the voltage of each of the piezoelectric elements 50 reaches the voltage V3c after the start of the gas discharge purge for the color, exceeds the time T3c in other cases.

According to the facts as described above, in a case where the change in the voltage of the piezoelectric element 50 during the suction purge is normal, and the change in the voltage of the piezoelectric element 50 during the gas discharge purge is normal, the maintenance unit 8 is highly likely to be normal. Therefore, in this case, the normality signal, which indicates that the maintenance unit 8 is normal, is outputted.

Further, in a case where the change in the voltage of the piezoelectric element 50 during the suction purge is abnormal, and the change in the voltage of the piezoelectric element 50 during the gas discharge purge is normal, the portion of the maintenance unit 8 relevant to the suction purge is highly likely to be abnormal. Therefore, in this case, the abnormality signal A, which indicates that at least any one of the first and second nozzle caps 81a, 81b, the liquid discharge flow passage, and the switching unit 84 of the maintenance unit 8 relevant to the suction purge is abnormal, is outputted.

Furthermore, in this case, any one of the abnormality signals A1, A2, A3 to display the abnormality screens 112A, 112B, 112D on the operation panel 99 respectively is outputted as the abnormality signal A based on whether the change in the voltage of the piezoelectric element 50 during the suction purge for the black is abnormal and whether the change in the voltage of the piezoelectric element 50 during the suction purge for the color is abnormal.

Moreover, in a case where the change in the voltage of the piezoelectric element 50 during the suction purge is normal, and the change in the voltage of the piezoelectric element 50 during the gas discharge purge is abnormal, there is a high possibility that the portion of the maintenance unit 8 relevant to the gas discharge purge may be abnormal. Therefore, in this case, the abnormality signal B, which indicates that at least any portion of the gas discharge cap 82, the gas discharge flow passage, and the switching unit 84 of the maintenance unit 8 relevant to the gas discharge purge is abnormal, is outputted.

Further, in this case, any one of the abnormality signals B1, B2, B3 for causing the operation panel 99 to display the abnormality screens 113A, 113B, 113C, respectively, is outputted as the abnormality signal B based on whether the change in the voltage of the piezoelectric element 50 during the gas discharge purge for the black is abnormal and whether the change in the voltage of the piezoelectric element 50 during the gas discharge purge for the color is abnormal.

Furthermore, in a case where the change in the voltage of the piezoelectric element 50 during the suction purge is abnormal, and the change in the voltage of the piezoelectric element 50 during the gas discharge purge is abnormal, the portion of the maintenance unit 8 relevant to both of the suction purge and the gas discharge purge is highly likely to be abnormal. Therefore, in this case, the abnormality signal C, which indicates that at least any one of the switching unit 84, the negative pressure pump 83, and the tube 19d of the maintenance unit 8 relevant to both of the suction purge and the gas discharge purge is abnormal, is outputted.

Moreover, the controller 100 may determine whether the maintenance unit 8 is abnormal based on the voltage of the piezoelectric element 50 during the gas discharge purge, without obtaining the voltage of the piezoelectric element 50 during the suction purge. In this case, the process for detecting whether at least a part of the maintenance unit 8 is abnormal can be simplified to such an extent that the voltage of the piezoelectric element 50 during the suction purge is not obtained, as compared with the case of the fifth modification.

For example, in a sixth modification, in a case where the controller 100 receives the cleaning instruction signal, the controller 100 performs the process in accordance with a flow chart indicated in FIG. 18A. The process will be described in detail below. In a case where the controller 100 receives the cleaning instruction signal, the controller 100 starts a voltage obtaining process (S701). The controller 100 executes a gas discharge purge process for the black (S702), and the controller 100 executes a gas discharge purge process for the color (S703). Subsequently, the controller 100 ends the voltage obtaining process (S704), and the controller 100 executes an abnormality detection process (S705). Further, after the abnormality detection process of S705, the controller 100 executes a suction purge process for the black (S706), and the controller 100 subsequently executes a suction purge process for the color (S707).

In the abnormality detection process of S705, the controller 100 outputs the signal depending on the change in the voltage of the piezoelectric element 50 obtained by the voltage obtaining process during the gas discharge purge for the black and the change in the voltage of the piezoelectric element 50 obtained by the voltage obtaining process during the gas discharge purge for the color.

Specifically, as depicted in FIG. 18B, in a case where the voltage of the piezoelectric element 50 obtained by the voltage obtaining process reaches the voltage V3k within the time T3k after the start of the gas discharge purge for the black, and the voltage of the piezoelectric element 50 obtained by the voltage obtaining process reaches the voltage V3c within the time T3c after the start of the gas discharge purge for the color, the controller 100 outputs the normality signal to the operation panel 99. By doing so, the controller 100 causes the operation panel 99 to display the normality screen 111 as depicted in FIG. 11C, in the same manner as the embodiment described above.

Further, in a case where the voltage of the piezoelectric element 50 obtained by the voltage obtaining process does not reach V3k within the time T3k after the start of the gas discharge purge for the black, and the voltage of the piezoelectric element 50 obtained by the voltage obtaining process reaches V3c within the time T3c after the start of the gas discharge purge for the color, the controller 100 outputs the abnormality signal B1 to the operation panel 99. By doing so, the controller 100 causes the operation panel 99 to display the abnormality screen 113A as depicted in FIG. 17B, in the same manner as the fifth modification.

Furthermore, in a case where the voltage of the piezoelectric element 50 obtained by the voltage obtaining process reaches V3k within the time T3k after the start of the gas discharge purge for the black, and the voltage of the piezoelectric element 50 obtained by the voltage obtaining process does not reach V3c within the time T3c after the start of the gas discharge purge for the color, the controller 100 outputs the abnormality signal B2 to the operation panel 99. Accordingly, the abnormality screen 113B, which is depicted in FIG. 17C, is displayed on the operation panel 99 in the same manner as the fifth modification.

Moreover, in a case where the voltage of the piezoelectric element 50 obtained by the voltage obtaining process does not reach V3k within the time T3k after the start of the gas discharge purge for the black, and the voltage of the piezoelectric element 50 obtained by the voltage obtaining process does not reach V3c within the time T3c after the start of the gas discharge purge for the color, the controller 100 outputs the abnormality signal B3 to the operation panel 99. By doing so, the controller 100 causes the operation panel 99 to display, an abnormality screen 113D, as depicted in FIG. 18C, which indicates that any one of the gas discharge cap 82, the gas discharge flow passage 66, the switching unit 84, and the negative pressure pump 83 of the maintenance unit 8 is abnormal.

In the sixth modification, in a case where the voltage of the piezoelectric element 50 does not reach the voltage V3k within the time T3k after the start of the gas discharge purge for the black and in a case where the voltage of the piezoelectric element 50 does not reach the voltage V3c within the time T3c after the start of the gas discharge purge for the color, the controller 100 outputs the abnormality signal which indicates that at least a part of the maintenance unit 8 is abnormal. By doing so, the existence of the abnormality in at least a part of the maintenance unit 8 including the negative pressure pump 83 can be detected by the simple configuration.

Further, in the sixth modification, the process may be ended after the abnormality detection process of S705 without performing the suction purge process for the black of S706 and the suction purge process for the color of S707.

Further, in the fifth and sixth modifications, for example, in accordance with the same or equivalent viewpoint as that of the first modification, whether the voltage of the piezoelectric element reaches a predetermined voltage during the gas discharge purge and the voltage of the piezoelectric element 50 is maintained at the predetermined voltage or more for a predetermined time or more after the gas discharge purge may be a condition for determining whether at least a part of the maintenance unit 8 is abnormal.

Further, in the embodiment described above and the first to fifth modifications, the different abnormality signals are outputted regarding the case in which the first liquid discharge-voltage condition is satisfied and the second liquid discharge-voltage condition is not satisfied, the case in which the first liquid discharge-voltage condition is not satisfied and the second liquid discharge-voltage condition is satisfied, and the case in which the first liquid discharge-voltage condition is not satisfied and the second liquid discharge-voltage condition is not satisfied. However, the present disclosure is not limited to this. For example, an identical abnormality signal may be outputted in the three cases. Note that in this case, the condition, in which at least one condition of the first liquid discharge-voltage condition and the second liquid discharge-voltage condition is satisfied, corresponds to the “liquid discharge-voltage condition” of the present disclosure.

Further, in the embodiments described above, the first nozzle cap 81a which covers the nozzles 40 from which the black ink is (to be) ejected and the second nozzle cap 81b which covers the nozzles 40 from which the color inks are (to be) ejected are provided distinctly, and the suction purge for the black and the suction purge for the color can be performed distinctly. However, the present disclosure is not limited to this. For example, the printer 1 may have a nozzle cap which covers all of the plurality of nozzles 40 of the ink-jet head 4. Further, the suction purge can be performed to discharge the inks inside the ink-jet head 4 from the plurality of nozzles 40 by driving the pump motor 83a of the negative pressure pump 83 in a state that the plurality of nozzles 40 is covered with the nozzle cap. Furthermore, in this case, in a case where the voltage of the piezoelectric element 50, which is obtained during the suction purge or after the suction purge, does not satisfy the liquid discharge-voltage condition, an abnormality signal, which indicates that at least a part of the maintenance unit 8 is abnormal, may be outputted.

Further, in the fifth and sixth modifications, the different abnormality signals are outputted, respectively, regarding the case in which the first gas discharge-voltage condition is satisfied and the second gas discharge-voltage condition is not satisfied, the case in which the first gas discharge-voltage condition is not satisfied and the second gas discharge-voltage condition is satisfied, and the case in which the first gas discharge-voltage condition is not satisfied and the second gas discharge-voltage condition is not satisfied. However, the present disclosure is not limited to this. For example, an identical abnormality signal may be outputted in the three cases. Note that in this case, the condition, in which at least one condition of the first gas discharge-voltage condition and the second gas discharge-voltage condition is satisfied, corresponds to the “gas discharge-voltage condition” of the present disclosure.

Further, in the embodiments described above, the shaft 86 which corresponds to the gas discharge flow passage 66 through which the black ink flows and the three shafts 86 which correspond to the gas discharge flow passages 66 through which the color inks flow can be lifted distinctly, thereby allowing the gas discharge purge for the black and the gas discharge purge for the color to be performed distinctly. However, the present disclosure is not limited to this. For example, the four shafts 86 may be connected to one another so that the four shafts 86 can be lifted in an integrated manner. Further, the gas discharge purge, in which the gas inside the four gas discharge flow passages 66 is discharged to the gas discharge cap 82, can be performed by driving the pump motor 83a of the negative pressure pump 83 after lifting the four shafts 86 to open the four valves 68 in the capped state. Further, in this case, in a case where the voltage of the piezoelectric element 50, which is obtained during the gas discharge purge or after the gas discharge purge, does not satisfy the gas discharge-voltage condition, an abnormality signal, which indicates that at least a part of the maintenance unit 8 is abnormal, may be outputted.

Further, the embodiments described above relate to the printer 1 which can perform the suction purge by the maintenance unit 8 including the negative pressure pump 83. However, the present disclosure is not limited to this.

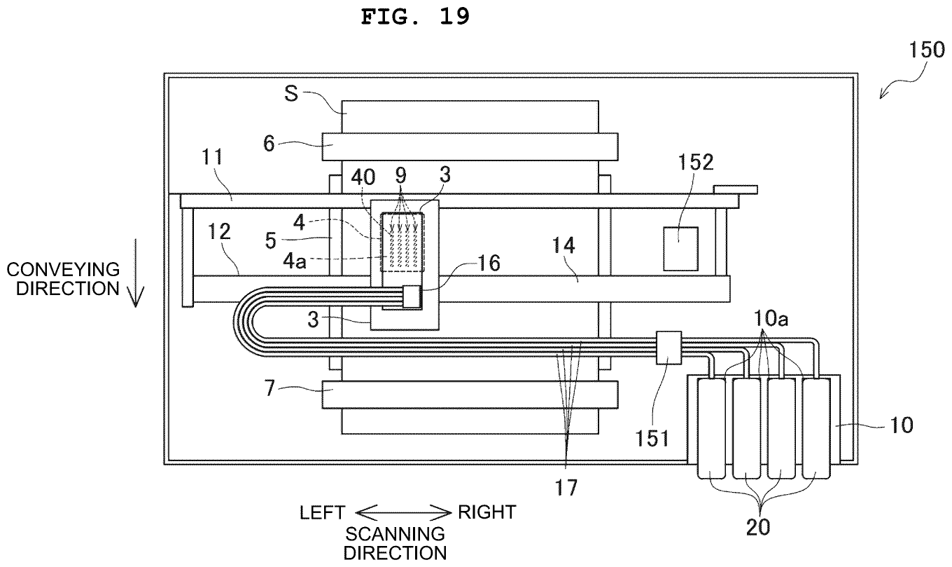

In a seventh modification, as depicted in FIG. 19, a printer 150 includes a positive pressure pump 151 and an ink receiving part 152, in place of the maintenance unit 8 of the printer 1. Further, the printer 150 does not have any constitutive component such as the gas discharge flow passage or the like for the gas discharge purge. However, the printer 150 may include the constitutive components for the gas discharge purge. Since the constitutive components of the printer 150 other than the above-described component(s) are approximately the same as those of the printer 1, any description of which will be omitted herein. Note that in the seventh modification, the ink receiving part 152 corresponds to the “liquid receiving part” of the present disclosure.

The positive pressure pump 151 is disposed with respect to the four tubes 17, and the positive pressure pump 151 applies the positive pressure to the inks inside the respective tubes 17. The ink receiving part 152 is disposed at the position in the printer 150 at which the nozzle cap unit 81 is disposed in the printer 1. Accordingly, in a case where the carriage 2 is moved to the maintenance position, the plurality of nozzles 40 of the ink-jet head 4 face the ink receiving part 152.

Further, in the seventh modification, the positive pressure purge, in which the inks inside the ink-jet head 4 are discharged from the plurality of nozzles 40 to the ink receiving part 152, can be performed by causing the positive pressure pump 151 to apply the positive pressure to the inks inside the four tubes 17 in a state that the carriage 2 is located at the maintenance position.

In the seventh modification, in a case where the controller 100 receives the cleaning instruction signal, the controller 100 performs the process in accordance with a flow chart indicated in FIG. 20A.

The process will be described in detail below. In a case where the controller 100 receives the cleaning instruction signal, the controller 100 starts a voltage obtaining process (S801). Subsequently, the controller 100 executes a positive pressure purge process (S802). In the positive pressure purge process, the controller 100 controls, for example, the carriage motor 106 and the positive pressure pump 151 to perform the positive pressure purge. Note that in the seventh modification, the positive pressure purge process corresponds to the “liquid discharge process” of the present disclosure. Further, in a case where the positive pressure purge is performed normally, the ink inside each of the plurality of pressure chambers 41 has the positive pressure. Accordingly, the portion of the piezoelectric layer 52, which covers each of the plurality of pressure chambers 41, is deformed, and the voltage is generated in the piezoelectric layer 52. In the voltage obtaining process started in S801, the controller 100 obtains the voltage, which is generated in the piezoelectric element 50 by the voltage generated in the piezoelectric layer 52.

Subsequently, the controller 100 ends the voltage obtaining process (S803), and the controller 100 executes an abnormality detection process (S804). In the abnormality detection process, as depicted in FIG. 20A, in a case where the voltage of the piezoelectric element 50, which is obtained in the voltage obtaining process, reaches a voltage V4 within a time T4 after the start of the gas discharge purge, the controller 100 outputs a normality signal to the operation panel 99. By doing so, as depicted in FIG. 20B, the controller 100 causes the operation panel 99 to display a normality screen 115, which indicates that the positive pressure pump 151 is normal.

Further, in a case where the voltage of the piezoelectric element 50, which is obtained in the voltage obtaining process, does not reach the voltage V4 within the time T4 after the start of the gas discharge purge, the controller 100 outputs an abnormality signal to the operation panel 99. By doing so, as depicted in FIG. 20C, the controller 100 causes the operation panel 99 to display an abnormality screen 116, which indicates that the positive pressure pump 151 is abnormal.

In a case where the positive pressure purge is performed normally, the pressure is the positive pressure in each of the plurality of pressure chambers 41 corresponding to one of the plurality of nozzles 40. Accordingly, the piezoelectric element 50, which forms the wall of each of the pressure chambers 41, is deformed, and the voltage of the piezoelectric element 50 changes. Further, the voltage of the piezoelectric element 50 reaches the voltage V4 within the time T4 after the start of the positive pressure purge. On the other hand, in a case where the positive pressure purge is not performed normally, the voltage of the piezoelectric element 50 does not reach the voltage V4 in some cases, and/or the time, until which the voltage of the piezoelectric element 50 reaches the voltage V4 after the start of the positive pressure purge, exceeds the time T4 in other cases.

In view of the above, in the seventh modification, in a case where the voltage of the piezoelectric element 50 does not reach the voltage V4 within the time T4 after the start of the positive pressure purge, the controller 100 outputs an abnormality signal, which indicates that the positive pressure pump 151 is abnormal. With this, the abnormality of the positive pressure pump 151 can be detected by the simple configuration.

Further, in the seventh modification, the output of any one of the normality signal and the abnormality signal is determined based on whether the condition, in which the voltage of the piezoelectric element 50 reaches the voltage V4 within the time T4 after the start of the positive pressure purge, is satisfied. However, the present disclosure is not limited to this.

For example, the output of any one of the normality signal and the abnormality signal may be determined based on whether the condition, in which the voltage of the piezoelectric element 50 reaches the voltage V4 during the positive pressure purge, is satisfied, irrelevant to the time after the start of the positive pressure purge. Alternatively, for example, the determination whether the output of any one of the normality signal and the abnormality signal may be made based on whether the condition, in which the voltage of the piezoelectric element 50 reaches the voltage V4 during the positive pressure purge and the state of the voltage of the piezoelectric element 50 being the voltage V4 or more for the predetermined time or more is maintained after the completion of the positive pressure purge, is satisfied.

Further, in the seventh modification, the positive pressure pump 151 is disposed in the tube 17. However, the present disclosure is not limited to this. For example, the positive pressure pump may be disposed in the cartridge holder 10, and the positive pressure pump may be configured such that the positive pressure can be applied to the ink inside the ink cartridge 20. In this way, the positive pressure pump may be disposed in any distinct portion which is disposed upstream regarding the flow of the ink as compared with the ink-jet head 4.

Further, the liquid discharge-voltage condition, the first liquid discharge-voltage condition, the second liquid discharge-voltage condition, and the gas discharge-voltage condition are not limited to the conditions described in the foregoing examples. At least one condition of the liquid discharge-voltage condition, the first liquid discharge-voltage condition, the second liquid discharge-voltage condition, and the gas discharge-voltage condition may be any condition which is different from the conditions described in the foregoing examples.

Further, in the examples described above, the voltage of one piezoelectric element 50 is obtained during the suction purge for the black and the color, during the gas discharge purge for the black and the color, and during the positive pressure purge. However, the voltages of two or more piezoelectric elements 50 may be obtained. In this case, for example, the existence of the abnormality in at least a part of the maintenance unit or in the positive pressure pump may be detected based on, for example, an average value, a maximum value, a minimum value, or a median of the voltages of the two or more piezoelectric elements 50.

Further, in the examples described above, the existence of the abnormality in the maintenance unit or the positive pressure pump is detected based on the change in the voltage of the piezoelectric element 50 configured to eject the inks from the nozzles 40 by applying the pressure to the inks inside the pressure chambers 41. However, the present disclosure is not limited to this. The wall of a flow passage portion other than the pressure chamber 41 of the ink flow passage in the ink-jet head may be formed by a piezoelectric element, and the existence of the abnormality in the maintenance unit or the positive pressure pump may be detected based on the change in the voltage of the piezoelectric element. For example, the flow passage in the ink-jet head may have a dummy pressure chamber which has the same or equivalent shape as the shape of the pressure chamber 41 but which is irrelevant to the ejection of the ink. The dummy pressure chamber may have a wall which is formed by a piezoelectric element. The existence of the abnormality in the maintenance unit or the positive pressure pump may be detected based on the change in the voltage of the piezoelectric element which forms the wall of the dummy pressure chamber.

Furthermore, in the examples described above, the abnormality signal is the signal for causing the operation panel 99 to display the abnormality screen which prompts the exchange of at least a part of the maintenance unit or the positive pressure pump. However, the present disclosure is not limited to this. For example, the printer may include an LED lamp. The abnormality signal may be a signal for causing the LED lamp to be turned ON or turned ON and OFF in order to inform a user of the existence of the abnormality in at least a part of the maintenance unit or the positive pressure pump. Alternatively, the printer may include a speaker. The abnormality signal may be a signal for causing the speaker to emit a sound in order to inform a user of the existence of the abnormality in at least a part of the maintenance unit or the positive pressure pump. Further alternatively, the abnormality signal may be a signal which is to be transmitted to an external apparatus such as PC or the like connected to the printer 1.

Moreover, in the examples described above, the normality signal is the signal which is provided in order that the normality screen, which indicates that the maintenance unit or the positive pressure pump is normal, is displayed on the operation panel 99. However, the present disclosure is not limited to this. For example, the printer may include an LED lamp. The normality signal may be a signal which is provided in order that the LED lamp is turned ON or turned ON and OFF in order to inform a user of the normality of the maintenance unit or the positive pressure pump. Alternatively, the printer may include a speaker. The normality signal may be a signal which is provided in order that a sound is emitted from the speaker in order to inform a user of the normality of the maintenance unit or the positive pressure pump. Further alternatively, the normality signal may be a signal which is to be transmitted to an external apparatus such as PC or the like connected to the printer 1.

Further, in the examples described above, in a case where the maintenance unit or the positive pressure pump is normal, the normality signal is outputted; and in a case where at least a part of the maintenance unit or the positive pressure pump is abnormal, the abnormality signal is outputted. However, the present disclosure is not limited to this. For example, in a case where at least a part of the maintenance unit or the positive pressure pump is abnormal, the abnormality signal may be outputted. In a case where the maintenance unit or the positive pressure pump is normal, no signal may be outputted.

Furthermore, in the examples described above, the ink is supplied to the ink-jet head 4 from the ink cartridge 20 which is removable with respect to the cartridge attaching part 10a. However, the present disclosure is not limited to this. For example, an ink tank, which has an ink supplement port, via which the ink tank is replenished with the ink from the outside, may be fixed to the printer, and the ink may be supplied from the ink tank to the ink-jet head 4. Note that in this case, the ink tank, which is fixed to the printer, corresponds to the “liquid retaining part” of the present disclosure.

Further, in the foregoing embodiments, the ejection inspection part 90 inspects whether the nozzle is the abnormal nozzle based on the inspection signal outputted from the signal processing circuit 93 depending on the change in the voltage of the electrode 91 disposed in the first and second nozzle cap 81a and 81b to eject the ink from the nozzle 40 in a case where the ink-jet head 4 performs the driving for inspection. However, the present disclosure is not limited to this.

For example, the ejection inspection part may have an electrode, in place of the electrode 91 of the ejection inspection part 90, the electrode extending in the vertical direction, and the electrode facing the space below the nozzles 40 in a state that the carriage 2 is located at the maintenance position. Further, the ejection inspection part may output a signal from the signal processing circuit 93 depending on the change in the voltage of the electrode in a case where the driving for inspection is performed in the state that the carriage 2 is located at the maintenance position. Whether the nozzle is the abnormal nozzle may be inspected based on the signal.

Alternatively, for example, the ejection inspection part may have an optical sensor which directly detects the ink ejected from the nozzle 40 and which outputs a signal depending on the detection result in a state that the carriage 2 is located at a predetermined position such as the maintenance position or the like. Further, whether the nozzle is the abnormal nozzle may be inspected based on the signal outputted from the optical sensor.

Alternatively, for example, the ejection inspection part may inspect whether the nozzle is the abnormal nozzle in the same manner as described in Japanese Patent No. 4929699. Specifically, in the ejection inspection part, a voltage detection circuit, which detects the change in the voltage when the ink is ejected from the nozzle, may be connected to a plate in which the nozzles of the ink-jet head are formed. Whether the nozzle is the abnormal nozzle may be inspected based on a signal outputted from the voltage detection circuit in a case where the operation is performed in order to eject the ink from the nozzle in a state that the carriage is moved to the inspection position.

Alternatively, for example, the ejection inspection part may inspect whether the nozzle is the abnormal nozzle in the same manner as described in Japanese Patent No. 6231759. Specifically, the ejection inspection part may include a temperature detecting element in relation to a substrate of the ink-jet head. Further, the ejection inspection part may drive a heater by applying a second application voltage so that the ink is not ejected after driving the heater by applying a first application voltage in order to eject the ink. Whether the nozzle is the abnormal nozzle may be inspected based on the change in the temperature detected by the temperature detecting element during a period until a predetermined time elapses after the application of the second application voltage.

Alternatively, for example, the ejection inspection part may inspect whether the nozzle is the abnormal nozzle in the same manner as described, for example, in Japanese Patent Application Laid-Open No. 2004-284189 and Japanese Patent Application Laid-Open No. 2011-240563 which corresponds to United States Patent Application Publication No. US 2011/0285773 A1. Specifically, in a case where the ink-jet head ejects the ink from the nozzle by applying, with the piezoelectric element the pressure to the ink inside the pressure chamber communicated with the nozzle, the ejection inspection part may include a remaining vibration type inspection device configured to detect the remaining vibration generated in the piezoelectric element by the pressure change in the ink inside the pressure chamber. Further, the ejection inspection part may inspect whether the nozzle is the abnormal nozzle based on the vibration pattern of the remaining vibration detected by the remaining vibration type inspection device in a case where the ink is ejected from the nozzle by driving the piezoelectric element.

Further, in the foregoing description, such an example has been described that the present disclosure is applied to the printer which includes the so-called serial head configured to eject the inks from the plurality of nozzles while moving in the scanning direction together with the carriage. However, the present disclosure is not limited to this. For example, the present disclosure is also applicable to a printer which includes a so-called line head extending over the entire length of a recording sheet in the scanning direction.

Further, in the foregoing description, such an example has been described that the present disclosure is applied to the printer for performing the recording on the recording sheet S by ejecting the inks from the nozzles. However, the present disclosure is not limited to this. The present disclosure is also applicable to any recording apparatus configured to record an image on a recording medium other than the recording sheet, including, for example, T-shirt, a sheet for outdoor advertisement, a case for a portable terminal such as a smartphone or the like, corrugated cardboard, and a resin member. Further, the present disclosure is also applicable to any liquid ejecting apparatus configured to eject any liquid other than the ink droplets, including, for example, a resin in a liquid form and a metal liquid.

What is claimed is:

1. A liquid ejecting apparatus comprising:
a head which has a head flow passage including a nozzle, and a piezoelectric element which forms a part of a wall of the head flow passage;
a cleaning part which has a nozzle cap configured to cover the nozzle, a negative pressure pump configured to generate a negative pressure, and a liquid discharge connecting flow passage which connects the nozzle cap and the negative pressure pump; and
a controller, wherein
the controller is configured to execute:
discharge of a liquid inside the head flow passage from the nozzle by driving the negative pressure pump in a state that the nozzle is covered with the nozzle cap;
obtainment of a voltage of the piezoelectric element during a period in which the liquid inside the head flow passage is being discharged from the nozzle; and
output of an abnormality signal indicating that at least a part of the cleaning part is abnormal in a case where the obtained voltage does not satisfy a liquid discharge-voltage condition.

2. The liquid ejecting apparatus according to claim 1, wherein
the liquid discharge-voltage condition is a condition that the voltage of the piezoelectric element reaches a predetermined voltage during the discharge of the liquid inside the head flow passage from the nozzle.

3. The liquid ejecting apparatus according to claim 2, wherein
the liquid discharge-voltage condition is a condition that the voltage of the piezoelectric element reaches the predetermined voltage within a first time after start of the discharge of the liquid inside the head flow passage from the nozzle.

4. The liquid ejecting apparatus according to claim 1, wherein
the controller is configured to obtain the voltage of the piezoelectric element during the period in which the liquid inside the head flow passage is being discharged from the nozzle and after the liquid inside the head flow passage has been discharged from the nozzle, and
the liquid discharge-voltage condition is a condition that the voltage of the piezoelectric element reaches a predetermined voltage during the discharge of the liquid inside the head flow passage from the nozzle, and the voltage of the piezoelectric element is maintained at the predetermined voltage or more for a second time or more after the discharge of the liquid inside the head flow passage from the nozzle is completed and driving of the negative pressure pump is stopped.

5. The liquid ejecting apparatus according to claim 1, further comprising a display, wherein
the controller causes the display to display a screen which prompts exchange of at least a part of the cleaning part upon receiving the abnormality signal.

6. The liquid ejecting apparatus according to claim 1, wherein
at least the part of the cleaning part is any one of entirety of the cleaning part, the nozzle cap, the negative pressure pump, and the liquid discharge connecting flow passage.

7. The liquid ejecting apparatus according to claim 1, wherein
the negative pressure pump includes a motor, and the negative pressure pump is configured to generate the negative pressure by driving the motor,
the motor is configured to output a driving state signal which indicates a driving state while the motor is being driven,
the controller is configured to execute obtainment of the driving state signal,
the controller is configured to output the abnormality signal which indicates that a portion of the cleaning part other than the motor is abnormal in a case where the liquid discharge-voltage condition is not satisfied and a driving signal condition regarding the driving state signal is satisfied, and
the controller is configured to output the abnormality signal which indicates that the motor is abnormal in a case where the liquid discharge-voltage condition is not satisfied and the driving signal condition is not satisfied.

8. The liquid ejecting apparatus according to claim 1, wherein
the head includes:
a first head flow passage which includes a first nozzle;
a second head flow passage which includes a second nozzle different from the first nozzle and which does not communicate with the first head flow passage;
a first piezoelectric element which is disposed of the first head flow passage; and
a second piezoelectric element which is disposed of the second head flow passage,
the cleaning part includes:
a first nozzle cap which is configured to cover the first nozzle;
a second nozzle cap which is configured to cover the second nozzle;
a first liquid discharge connecting flow passage which is connected to the first nozzle cap;
a second liquid discharge connecting flow passage which is connected to the second nozzle cap; and
a switching part which performs switching between a state that the first liquid discharge connecting flow passage is connected to the negative pressure pump and a state that the second liquid discharge connecting flow passage is connected to the negative pressure pump,
the controller executes:
discharge of the liquid inside the first head flow passage from the first nozzle by driving the negative pressure pump in a state that the first nozzle is covered with the first nozzle cap and the first liquid discharge connecting flow passage and the negative pressure pump are connected by the switching part; and
discharge of the liquid inside the second head flow passage from the second nozzle by driving the negative pressure pump in a state that the second nozzle is covered with the second nozzle cap and the second liquid discharge connecting flow passage and the negative pressure pump are connected by the switching part,
the obtainment of the voltage includes:
obtainment of a voltage of the first piezoelectric element during a period in which the liquid inside the first head flow passage is being discharged from the first nozzle; and
obtainment of a voltage of the second piezoelectric element during a period in which the liquid inside the second head flow passage is being discharged from the second nozzle, and
the controller is configured to output the abnormality signal in at least one of a case where the obtained voltage of the first piezoelectric element does not satisfy a first liquid discharge-voltage condition and a case where the obtained voltage of the second piezoelectric element does not satisfy a second liquid discharge-voltage condition.

9. The liquid ejecting apparatus according to claim 8, wherein
the controller is configured to output the abnormality signal which indicates that at least any one of the first nozzle cap, the first liquid discharge connecting flow passage, and the switching part of the cleaning part is abnormal in a case where the obtained voltage of the first piezoelectric element does not satisfy the first liquid discharge-voltage condition and the obtained voltage of the second piezoelectric element satisfies the second liquid discharge-voltage condition, and
the controller is configured to output the abnormality signal which indicates that at least any one of the second nozzle cap, the second liquid discharge connecting flow passage, and the switching part of the cleaning part is abnormal in a case where the obtained voltage of the first piezoelectric element satisfies the first liquid discharge-voltage condition and the obtained voltage of the second piezoelectric element does not satisfy the second liquid discharge-voltage condition.

10. The liquid ejecting apparatus according to claim 8, wherein
the controller is configured to output a normality signal which indicates that the cleaning part is normal in a case where the obtained voltage of the first piezoelectric element satisfies the first liquid discharge-voltage condition and the obtained voltage of the second piezoelectric element satisfies the second liquid discharge-voltage condition.

11. The liquid ejecting apparatus according to claim 8, wherein
the controller is configured to output the abnormality signal which indicates that at least any one of the negative pressure pump and the switching part of the cleaning part is abnormal in a case where the obtained voltage of the first piezoelectric element does not satisfy the first liquid discharge-voltage condition and the obtained voltage of the second piezoelectric element does not satisfy the second liquid discharge-voltage condition.

12. The liquid ejecting apparatus according to claim 1, wherein
the controller is configured to execute the discharge of the liquid inside the head flow passage from the nozzle, the obtainment of the voltage of the piezoelectric element, and the output of the abnormality signal in a case where the controller receives an instruction signal which is given by a user and which instructs the controller to execute the discharge of the liquid inside the head flow passage from the nozzle.

13. The liquid ejecting apparatus according to claim 1, further comprising an ejection inspection signal output part which is configured to output an ejection inspection signal depending on whether the ejection of the liquid from the nozzle is abnormal in a case where driving for inspection of ejecting the liquid from the nozzle is performed in the head, wherein
in a case where the controller causes the head to perform the driving for inspection and where the ejection inspection signal, which is outputted from the ejection inspection signal output part, indicates that the ejection of the liquid from the nozzles is abnormal, the controller is configured to executes the discharge of the liquid inside the head flow passage from the nozzles, the obtainment of the voltage of the piezoelectric element, and the output of the abnormality signal.

14. The liquid ejecting apparatus according to claim 1, wherein
the head flow passage includes a plurality of nozzles including the nozzle;
the liquid ejecting apparatus further comprises an ejection inspection signal output part which is configured to output an ejection inspection signal depending on whether the ejection of the liquid from the nozzles is abnormal in a case where driving for inspection of ejecting the liquid from the nozzles is performed in the head,
the controller is configured to cause the head to perform the driving for inspection regarding each of the plurality of nozzles and execute obtainment of first ejection inspection information regarding a number of nozzles included in the plurality of nozzles and having the abnormality in the ejection of the liquid, based on the ejection inspection signal outputted from the ejection inspection signal output part during the driving for inspection,
the controller is configured to execute the discharge of the liquid inside the head flow passage from each of the plurality of nozzles after the obtainment of the first ejection inspection information and to further cause the head to perform the driving for inspection again regarding at least each of the nozzles, included in the plurality of nozzles, having the abnormality in the ejection of the liquid so as to execute obtainment of second ejection inspection information regarding a number of the nozzles having the abnormality in the ejection of the liquid, based on the ejection inspection signal outputted from the ejection inspection signal output part during the driving for inspection performed again,
in a case where a difference condition is satisfied regarding a difference between the number of the nozzles having the abnormality in the ejection of the liquid indicated by the first ejection inspection information and the number of the nozzles having the abnormality in the ejection of the liquid indicated by the second ejection inspection information, the controller is configured to execute the obtainment of the voltage of the piezoelectric element and the output of the abnormality signal in a case where the controller performs the discharge of the liquid inside the head flow passage from the nozzle next time, and
in a case where the difference condition is not satisfied, the controller is configured not to execute the obtainment of the voltage of the piezoelectric element and the output of the abnormality signal in a case where the controller performs the discharge of the liquid inside the head flow passage from the nozzle the next time.

15. The liquid ejecting apparatus according to claim 1, wherein
the head includes a plurality of nozzles including the nozzle;
the head further includes:
the head flow passage including: a plurality of individual flow passages each of which individually corresponds to one of the plurality of nozzles; and a common flow passage connected to the plurality of individual flow passages; and
a plurality of piezoelectric elements including the piezoelectric element, wherein each of the piezoelectric elements is disposed individually for one of the plurality of individual flow passages and is configured to apply a pressure to the liquid inside one of the plurality of individual flow passages so as to eject the liquid from one of the plurality of nozzles,
the liquid ejecting apparatus further comprises:
a storage part; and
an ejection inspection signal output part which is configured to output an ejection inspection signal depending on whether the ejection of the liquid from the nozzle is abnormal in a case where driving for inspection is performed in order to eject the liquid from each of the plurality of nozzles of the head,
the controller is configured to cause each of the plurality of nozzles to perform the driving for inspection, and to execute storage of causing the storage part to store ejection inspection information regarding whether the ejection of the liquid is abnormal based on the ejection inspection signal outputted from the ejection inspection signal output part during the driving for inspection, and
in a case where the controller executes the obtainment of the voltage of the piezoelectric element, the controller is configured to execute obtainment of the voltage of a piezoelectric element, of the plurality of piezoelectric elements, disposed with respect to an individual flow passage, of the plurality of individual flow passages, including a nozzle, of the plurality of nozzles, regarding which the ejection inspection information stored in the storage part indicates that the ejection of the liquid is normal.

16. The liquid ejecting apparatus according to claim 1, wherein
the head flow passage includes a liquid supply port,
the liquid ejecting apparatus further comprises:
a liquid retaining part which is configured to retain the liquid to be supplied to the head flow passage; and
a supply flow passage which connects the liquid supply port and the liquid retaining part,
the liquid ejecting apparatus further comprises:
a gas discharge flow passage which is branched from the supply flow passage and which has a gas discharge port;
a gas discharge cap which is configured to cover the gas discharge port;
a gas discharge connecting flow passage which is configured to connect the gas discharge cap and the negative pressure pump; and
a switching part which is configured to perform switching between a state that the liquid discharge connecting flow passage and the negative pressure pump are connected and a state that the gas discharge connecting flow passage and the negative pressure pump are connected,
the controller executes:
driving of the negative pressure pump in a state that the nozzle is covered with the nozzle cap and the liquid discharge connecting flow passage and the negative pressure pump are connected by the switching part in the discharge of the liquid inside the head flow passage from the nozzle; and
discharge of a gas inside the head flow passage from the discharge port by driving the negative pressure pump in a state that the gas discharge port is covered with the gas discharge cap and the gas discharge connecting flow passage and the negative pressure pump are connected by the switching part,
the obtainment of the voltage of the piezoelectric element includes:
obtainment of the voltage of the piezoelectric element during the period in which the liquid inside the head flow passage is being discharged from the nozzle; and
obtainment of the voltage of the piezoelectric element during a period in which the gas inside the head flow passage is being discharged from the gas discharge port, and
the output of the abnormality signal is configured such that:
a normality signal, which indicates that the cleaning part is normal, is outputted in a case where the voltage, which is obtained during the period in which the liquid inside the head flow passage is being discharged from the nozzle, satisfies the liquid discharge-voltage condition and where the voltage, which is obtained during the period in which the gas inside the head flow passage is being discharged from the gas discharge port, satisfies the gas discharge-voltage condition;
the abnormality signal, which indicates that at least any one of the nozzle cap, the liquid discharge connecting flow passage, and the switching part of the cleaning part is abnormal, is outputted in a case where the voltage, which is obtained during the period in which the liquid inside the head flow passage is being discharged from the nozzle, does not satisfy the liquid discharge-voltage condition and where the voltage, which is obtained during the period in which the gas inside the head flow passage is being discharged from the gas discharge port, satisfies the gas discharge-voltage condition;
the abnormality signal, which indicates that at least any one of the gas discharge cap, the gas discharge connecting flow passage, and the switching part of the cleaning part is abnormal, is outputted in a case where the voltage, which is obtained during the period in which the liquid inside the head flow passage is being discharged from the nozzle, satisfies the liquid discharge-voltage condition and where the voltage, which is obtained during the period in which the gas inside the head flow passage is being discharged from the gas discharge port, does not satisfy the gas discharge-voltage condition, or
the abnormality signal, which indicates that at least any one of the switching part and the negative pressure pump of the cleaning part is abnormal, is outputted in a case where the voltage, which is obtained during the period in which the liquid inside the head flow passage is being discharged from the nozzle, does not satisfy the liquid discharge-voltage condition and where the voltage, which is obtained during the period in which the gas inside the head flow passage is being discharged from the gas discharge port, does not satisfy the gas discharge-voltage condition.

17. A liquid ejecting apparatus comprising:
a head which includes a head flow passage including a nozzle, and a piezoelectric element which forms a part of a wall of the head flow passage;
a positive pressure pump which is configured to apply a positive pressure to a liquid inside the head flow passage;
a liquid receiving part which is configured to receive the liquid discharged from the nozzle; and
a controller, wherein
the controller is configured to execute:
discharge of the liquid inside the head flow passage from the nozzle to the liquid receiving part by driving the positive pressure pump;
obtainment of a voltage of the piezoelectric element during a period in which the liquid inside the head flow passage is being discharged from the nozzle to the liquid receiving part; and
output of an abnormality signal which indicates that the positive pressure pump is abnormal in a case where the obtained voltage does not satisfy a liquid discharge-voltage condition.

18. A liquid ejecting apparatus comprising:
a head which includes a head flow passage having a nozzle and a liquid supply port, and a piezoelectric element which forms a part of a wall of the head flow passage;
a liquid retaining part which is configured to retain a liquid to be supplied to the head flow passage;
a supply flow passage which connects a discharge port and the liquid retaining part;
a gas discharge flow passage which is branched from the supply flow passage and which has a gas discharge port;
a cleaning part which has a gas discharge cap configured to cover the gas discharge port, a negative pressure pump configured to generate a negative pressure, and a gas discharge connecting flow passage which connects the gas discharge cap and the negative pressure pump; and
a controller, wherein
the controller is configured to execute:
discharge of a gas inside the head flow passage from the gas discharge port by driving the negative pressure pump in a state that the gas discharge port is covered with the gas discharge cap;
obtainment of a voltage of the piezoelectric element during a period in which the gas inside the head flow passage is being discharged from the gas discharge port; and
output of an abnormality signal which indicate that at least a part of the cleaning part is abnormal in a case where the obtained voltage does not satisfy a gas discharge-voltage condition.
